(19) United States
(12) Patent Application Publication
(10) Pub. No.: US 2015/0127820 A1
(43) Pub. Date: May 7, 2015

(54) APPARATUS AND METHOD FOR SEARCHING ACROSS GROUPS OF NETWORKED DEVICES FOR DEVICES HAVING A SAME FUNCTION

(71) Applicant: FUJITSU LIMITED, Kawasaki-shi (JP)

(72) Inventors: Shinya KITAJIMA, Inagi (JP); Tetsuya UCHIUMI, Kawasaki (JP); Shinji KIKUCHI, Yokohama (JP); Yasuhide MATSUMOTO, Kawasaki (JP)

(73) Assignee: FUJITSU LIMITED, Kawasaki-shi (JP)

(21) Appl. No.: 14/514,548

(22) Filed: Oct. 15, 2014

(30) Foreign Application Priority Data
Nov. 6, 2013 (JP) 2013-230531

(51) Int. Cl. H04L 12/26; H04L 29/12

(52) U.S. Cl. CPC H04L 43/04; H04L 61/2517
USPC 709/224

(57) ABSTRACT

A search device in a system in which first and second device groups are connected to each other, acquires first history information that specifies transmission sources and transmission destinations of communication executed between devices in the first device group, and second history information that specifies transmission sources and transmission destinations of communication executed between devices in the second device group. The search device searches across the first and second history information for a pair of a first device in the first group and a second device in the second group, by comparing the first and second history information, where the first device has a same function as the second device.

### CROSS-REFERENCE TO RELATED APPLICATION

This application is based upon and claims the benefit of priority of the prior Japanese Patent Application No. 2013-230531, filed on Nov. 6, 2013, the entire contents of which are incorporated herein by reference.

### FIELD

The embodiments discussed herein are related to apparatus and method for searching across groups of networked devices for devices having a same function.

### BACKGROUND

In a large-sized system such as a cloud system, a manager extends hardware of the cloud system to cope with an increase in resource request due to an increase in the number of users of the cloud system. During the extension, the manager extends the hardware in a subsystem unit in which plural pieces of hardware are integrated in one unit.

When extending the subsystem, the manager makes a first configuration of the subsystem to be extended be the same or substantially the same as that of a second configuration of an existing subsystem. The above-described first configuration and second configuration are each, for example, a hardware configuration or a software configuration. The manager may partially customize, for the subsystem to be extended, various kinds of setting information and the like which are set in hardware or software of the existing subsystem. In addition, the manager sets various kinds of setting information and the like, which are customized, to hardware or software of the subsystem to be extended.

Since a function of the subsystem to be extended is the same or substantially the same as a function of the existing subsystem, the manager further may perform the customization in a state in which the first configuration and the second configuration are made to be the same or substantially the same as each other.

In a case where the manager partially customizes various kinds of setting information and sets the partially customized information to hardware or software of the subsystem to be extended, a setting error may occur. The setting error frequently relates to a setting of information (hereinafter, may be referred to as communication-related information) such as an Internet protocol (IP) address or a port number that relates to network communication (hereinafter, may be referred to as communication).

In addition, in a distributed system that is configured by connecting a plurality of apparatuses to a network, a method of enabling communication by automatically setting the apparatuses has been suggested.

Japanese Laid-open Patent Publication Nos. 2000-269998, 2012-198818, and 2002-278853 are examples of the related art.

### SUMMARY

According to an aspect of the invention, a search device is provided in a system in which first and second device groups are connected to each other. The search device acquires first history information that specifies transmission sources and transmission destinations of communication executed between devices in the first device group, and second history information that specifies transmission sources and transmission destinations of communication executed between devices in the second device group. The search device searches across the first and second history information for a pair of a first device in the first group and a second device in the second group, by comparing the first and second history information, where the first device has the same function as the second device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing system, according to an embodiment;

FIG. 2 is a diagram illustrating an example of a configuration of server groups, according to an embodiment;

FIG. 3 is a diagram illustrating an example of a configuration of a server group, according to an embodiment;

FIG. 4 is a diagram illustrating an example of a configuration of a server, according to an embodiment;

FIG. 5 is a diagram illustrating an example of a hardware configuration of a management device, according to an embodiment;

FIG. 6 is a diagram illustrating an example of a functional configuration of a management device, according to an embodiment;

FIG. 7 is a diagram illustrating an example of an operational flowchart for a process of determining a same functional server, according to an embodiment;

FIG. 8 is a diagram illustrating an example of a first table indicating a communication log database, according to an embodiment;

FIG. 9 is a diagram illustrating an example of a table indicating a state in which standby port numbers are listed, according to an embodiment;

FIG. 10 is a diagram illustrating an example of a table storing standby port number logs created from communication logs of first and second blocks, according to an embodiment;

FIG. 11 is a diagram illustrating an example of determination of a same functional server based on a transmission destination IP address, a transmission source IP address, and a port number, according to an embodiment;

FIG. 12 is a diagram illustrating an example of a first table indication determination of a same functional server based on a specific port number with respect to an undetermined server, according to an embodiment;

FIG. 13 is a diagram illustrating an example of a second table indicating determination of a same functional server based on a specific port number with respect to an undetermined server, according to an embodiment;

FIG. 14 is a diagram illustrating an example of a method of analogizing a same function server, according to an embodiment;

FIG. 15 is a diagram illustrating an example of a table storing standby port number logs, according to an embodiment;

FIG. 16 is a diagram illustrating an example of a first table indicating calculation results of a degree of similarity, according to an embodiment;

FIG. 17 is diagram illustrating an example of a second table indicating calculation results of a degree of similarity, according to an embodiment;

FIG. 18 is a diagram illustrating an example of tables that store information on determined same functional servers and undetermined servers, according to an embodiment;

FIG. 19 is a diagram illustrating an example of a second table indicating a communication log database, according to an embodiment;

FIG. 20 is a diagram illustrating an example of a third table indicating a communication log database, according to an embodiment;

FIG. 21 is a diagram illustrating an example of a table indicating a server-corresponding database, according to an embodiment;

FIG. 22 is a diagram illustrating an example of an operational flowchart for a process of acquiring a communication log and merging a communication log, according to an embodiment;

FIG. 23 is a diagram illustrating an example of a process of acquiring and merging a communication log, according to an embodiment;

FIG. 24 is a diagram illustrating an example of a table indicating a process of converting a communication log, according to an embodiment;

FIG. 25 is a diagram illustrating an example of a communication log table to which a matching or non-matching column is added, according to an embodiment;

FIG. 26 is a diagram illustrating an example of an operational flow chart for a process of comparing communication logs and detecting a setting error, according to an embodiment;

FIG. 27 is a diagram illustrating an example of an operational flowchart for comparing communication logs and detecting a setting error, according to an embodiment;

FIG. 28 is a diagram illustrating an example of matching or non-matching of a communication log in a state in which both of a transmission source port number and a transmission destination port number are merged, according to an embodiment;

FIG. 29 is a diagram illustrating an example of matching or non-matching of a communication log in a state in which both of the transmission source port number and the transmission destination port number are not merged with each other, according to an embodiment;

FIG. 30 is a diagram illustrating an example of setting error candidate extraction, according to an embodiment; and

FIGS. 31 to 33 are diagrams illustrating an example of a process of detecting a setting error, according to an embodiment.

### DESCRIPTION OF EMBODIMENTS

To avoid the setting error, it may be considered to use the above-described method. However, in the above-described method, it is difficult to set an IP address and a port number, which are partially customized for a subsystem to be extended, to hardware and the like of a subsystem to be extended.

Therefore, a manager manually customizes communication-related information such as the IP address and the port number and sets the customized information to hardware and the like. After the extension of the subsystem, the manager verifies that the subsystem appropriately operates, before system operation.

During the verification, it is desirable for the manager to quickly grasp the contents of the setting error and to correct the setting error. However, it is complicated and difficult for the manager to manually detect the setting error. Particularly, when the setting error frequently occurs along with an increase in the size of the system to be extended, the manual detection of the setting error by the manager is significantly complicated and difficult.

Accordingly, the following method is suggested to detect the setting error by verifying the operation of the subsystem to be extended. In this method, a first communication history of an existing subsystem and a second communication history of a subsystem to be extended are compared with each other, and the setting error is automatically detected based on a comparison result. In a case of executing the method, as described below, it is desirable to register information relating to devices in the subsystem to be extended and information relating to devices in the existing subsystem, to a device that detects the setting error, in order to execute the comparison with high accuracy.

The manager manually creates the information in advance, but man-hours for the creation increase in proportion to the number of the devices in the subsystem to be extended. In addition, if the manager has no knowledge of the devices in the subsystem to be extended and the devices in the existing subsystem, the manager is not able to create the information. Particularly, when the size of the subsystem to be extended increases, it is difficult for the manager to manually create the above-described information when also considering working man-hours and device-related information.

According to an embodiment, a technique of automatically creating information that is used during automatic detection of a communication-related information setting error is provided.

Information Processing System

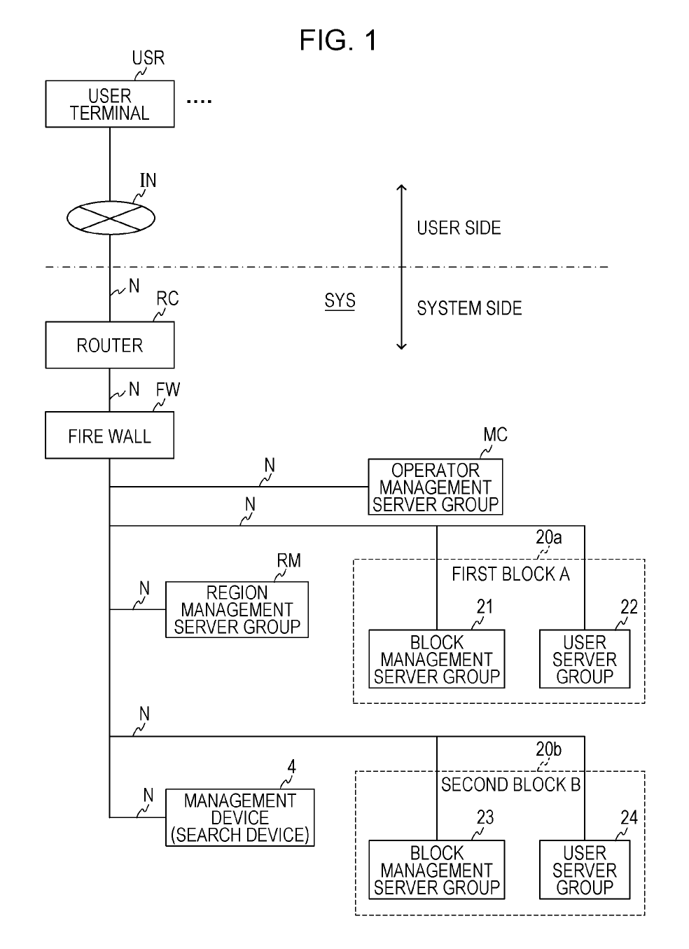

FIG. 1 is a diagram illustrating an example of a configuration of an information processing system, according to an embodiment. In the following description, the same reference numerals are given to elements having the same functions, and a description of the elements will be appropriately omitted. In this embodiment, the information processing system SYS is a cloud system. The information processing system SYS includes a router RC, a fire wall FW, an operator management server group MC, a region management server group RM, a first block A 20a, a second block B 20b, and a management device (search device) 4 which are connected to a network N. For example, the network N is a local area network (LAN). In addition, each of the blocks is also called a data center. Hereinafter, the management device (search device) 4 is abbreviated as a management device 4.

The information processing system SYS is connected to a user terminal USR that is operated by a user of the cloud system through the Internet IN. The information processing system SYS performs data processing in response to a data processing request transmitted from the user terminal USR, and transmits a processing result to the user terminal USR. In FIG. 1, only one user terminal USR is illustrated for convenience of description. However, a plurality of user terminals are connected to the information processing system SYS through the Internet IN. In addition, an upper side of FIG. 1 based on a one-dot chain line represents a user side, and a lower side of FIG. 1 based on the one-dot chain line represents an information processing system SYS side.

The router RC is a communication device that connects the Internet IN and the network N inside the information processing system SYS to each other. The fire wall FW is a device having a so-called fire wall function that makes illegal access to the network N inside the information processing system SYS unable to occur. The operator management server group MC is a server group that operates the information processing system SYS, and includes a plurality of servers that execute this operation process.

The first block A 20a is an existing subsystem and includes a block management server group 21 and a user server group 22. The user server group 22 includes a plurality of servers that execute various kinds of data processing in response to a request transmitted from the user terminal USR. The block management server group 21 includes a plurality of servers that manage the user server group 22. With regard to the block management server group 21 and the user server group 22 in the first block A 20a, operation verification is already completed. The first block A 20a is also called a first block A 20a in which the operation verification is completed or a first block A 20a in which construction is completed. The completion of operation verification represents a state in which operation verification for verifying that an appropriate operation of a server group (for example, the first block A 20a) based on design specifications has been executed is completed.

The second block B 20b is a subsystem to be extended, and includes a block management server group 23 and a user server group 24. The user server group 24 includes a plurality of servers that perform various kinds of data processing in response to a request transmitted from the user terminal USR. The block management server group 23 includes a plurality of servers that manage the user server group 24. With regard to the block management server group 23 and the user server group 24 in the second block B 20b, operation verification is not completed. The second block B 20b is also called a second block B 20b that is an operation verification target, a second block B 20b in which operation verification is not performed, or a second block B 20b during construction.

The region management server group RM is a device that manages the first block A 20a and the second block B 20b, and includes a plurality of servers that perform this management process.

The management device 4 is a device that manages the overall operation verification in a case of performing the operation verification of the subsystem that is an operation verification target.

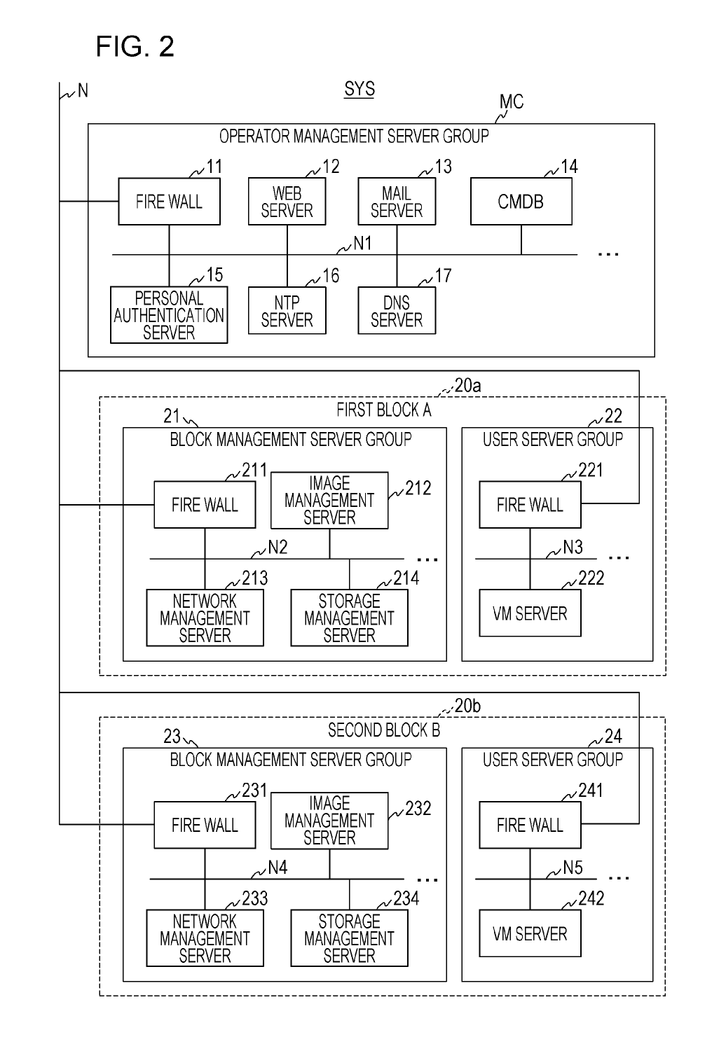

FIG. 2 is a diagram illustrating an example of a configuration of server groups, according to an embodiment. FIG. 2 shows a hardware block diagram of an operator management server group MC, the first block A 20a, and the second block B 20b in FIG. 1. The operator management server group MC includes a fire wall 11, a WEB server 12, a mail server 13, a configuration management database (CMDB) 14, a personal authentication server 15, a network time protocol (NTP) server 16, and a domain name system (DNS) server 17 which are connected to each other through a network N1.

The fire wall 11 is a device having a so-called fire wall function that makes illegal access to the network N1 inside the operator management server group MC unable to occur. The WEB server 12 provides HTML data that is described in a hypertext markup language (HTML) in response to a request transmitted from a web browser of a client. The mail server 13 transmits and receives electronic mail, and functions as, for example, a simple mail transfer protocol (SMTP) server or a post office protocol (POP) server.

The CMDB 14 is a database that collects configuration information of a component that constitutes the information processing system SYS, and collectively manages the configuration information that is collected. For example, the component is hardware or software. In addition, examples of the hardware include a server that is an information processing device, a network device such as a router and a switch, and a storage device such as a hard disk drive (HDD). The personal authentication server 15 authenticates a user of the cloud system. The NTP server 16 synchronizes time set to each server to correct time. The DNS 17 is a server that manages, for example, correlation between a domain name of a server in the information processing system SYS and an IP address that is set to the server.

A user server group 22 of the first block A 20a includes a fire wall 221 and a VM server 222 which are connected to a network N3. VM is an abbreviation of a virtual machine. In addition, in the user server group 22, only one fire wall 221 and only one VM server 222 are illustrated for convenience of description, but the user server group 22 may include a plurality of the fire walls 221 and a plurality of the VM servers 222. Additionally, the user server group 22 may also include a network device or a storage device.

The fire wall 221 is a device of executing a so-called fire wall function of making illegal access to the network N3 in the user server group 22 unable to occur. The VM server 222 executes the virtual machine (VM) that virtualizes a hardware resource of the server or the like, and performs various kinds of data processing, for example, in response to a request transmitted from a user. Additionally, the VM server 222 may execute virtual routing (VR).

A block management server group 21 includes a fire wall 211, an image management server 212, a network management server 213, and a storage management server 214 which are connected to a network N2. The fire wall 211 is a device that executes a so-called fire wall function of making illegal access to the network N2 in the block management server group 21 unable to occur.

The image management server 212 manages a VM image of the virtual machine that is executed by the VM server 222 of the user server group 22. For example, the image management server 212 manages the amount of a hardware resource that is allocated to each virtual machine that is executed by the VM server 222 of the user server group 22. The network management server 213 manages a communication device in the user server group 22, and various kinds of setting information (IP address and the like) of the communication device. For example, the network management server 213 manages the fire wall 211 of the user server group 22, an IP address that is set to the VM server 222, and an IP address that is set to the virtual machine that is executed by the VM server 222.

The storage management server 214 manages a storage (not illustrated) of the user server group 22. For example, the storage management server 214 manages configuration information of a storage (not shown) that is allocated to the virtual machine that is executed by the VM server 222, or performance information such as a storage capacity of the storage. Additionally, the block management server group 21 may include various servers such as a WEB server, a mail server, CMDB, and a DNS server.

A user server group 24 of the second block B 20b includes a fire wall 241 and a VM server 242 which are connected to a network N5. In addition, in the user server group 24, only one fire wall 241 and only one VM server 242 are illustrated for convenience of description, but the user server group 24 may include a plurality of the fire walls 241 and a plurality of the VM servers 242. Additionally, the user server group 24 may include a network device such as a router and a switch, and a storage device.

The fire wall 241 is a device that executes a so-called fire wall function of making illegal access to the network N5 in the user server group 24 unable to occur. The VM server 242 executes a virtual machine that virtualizes a hardware resource of the server or the like, and performs various kinds of data processing, for example, in response to a request transmitted from a user. Additionally, the VM server 242 may execute a virtual router (VR).

A block management server group 23 includes a fire wall 231, an image management server 232, a network management server 233, and a storage management server 234 which are connected to a network N4. The fire wall 231 is a device that executes a so-called fire wall function of making illegal access to the network N4 in the block management server group 23 unable to occur.

The image management server 232 manages a VM image of the virtual machine that is executed by the VM server 242 of the user server group 24. For example, the image management server 232 manages the amount of a hardware resource that is allocated to each virtual machine that is executed by the VM server 242 of the user server group 24. The network management server 233 manages a communication device in the user server group 24, and various kinds of setting information (IP address and the like) of the communication device. For example, the network management server 233 manages the fire wall 241 of the user server group 24, an IP address that is set to the VM server 242, and an IP address that is set to the virtual machine that is executed by the VM server 242.

The storage management server 234 manages the storage (not illustrated) of the user server group 24. For example, the storage management server 234 manages configuration information of the storage (not illustrated) that is allocated to the virtual machine that is executed by the VM server 242, or performance information such as the capacity of the storage. Additionally, the block management server group 23 may include various servers such as a WEB server, a mail server, CMDB, and a DNS server.

A process, which is executed by the information processing system SYS in a case where a user uses a cloud service, will be described with reference to FIGS. 1 and 2. The cloud service is an information processing service that is executed by the information processing system SYS. The user accesses the information processing system SYS by operating the user terminal USR in FIG. 1. Specifically, the user operates the user terminal USR to transmit, for example, a user identifier (ID) and a password to the personal authentication server 15 in FIG. 2, and makes a request for authentication.

The personal authentication server 15 authenticates the user based on the user ID and the password which are transmitted. When the authentication by the personal authentication server 15 is successful, for example, the image management server 212 of the block management server group 21 in FIG. 2 gives an instruction for the VM server 222 of the user server group 22 to activate and execute a virtual machine for the user. The VM server 222 activates the virtual machine for the user in response to the instruction to set the virtual machine to an operation state. Then, the user accesses the virtual machine through the user terminal USR to perform various kinds of data processing.

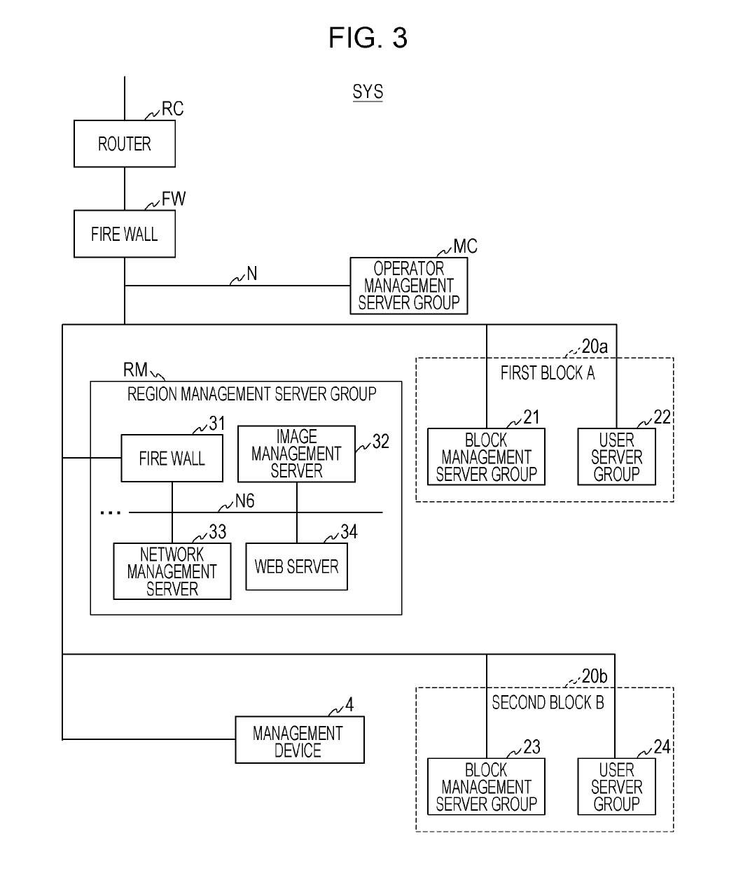

Description of information processing system SYS described with reference to FIGS. 1 and 2 will be continued. FIG. 3 is a diagram illustrating an example of a configuration of a server group, according to an embodiment. FIG. 3 shows a hardware block diagram of a region management server group RM in FIG. 1. The region management server group RM includes a fire wall 31, an image management server 32, a network management server 33, and a WEB server 34 which are connected to a network N6 in the region management server group RM.

The fire wall 31 is a device that executes a so-called fire wall function of making illegal access to the network N6 in the region management server group RM unable to occur. The image management server 32 is a server that manages configuration information of a virtual machine that is executed by the image management server 212 of the block management server group 21, or configuration information of a virtual machine that is executed by the image management server 232 of the block management server group 23. In addition to this, the image management server 32 manages an IP address of the image management server 212 or an IP address of the image management server 232.

The network management server 33 is a server that manages an IP address of the network management server 213 of the block management server group 21, or an IP address of the network management server 233 of the block management server group 23. The WEB server 34 provides HTML data described in HTML in response to a request transmitted from the web browser of a client.

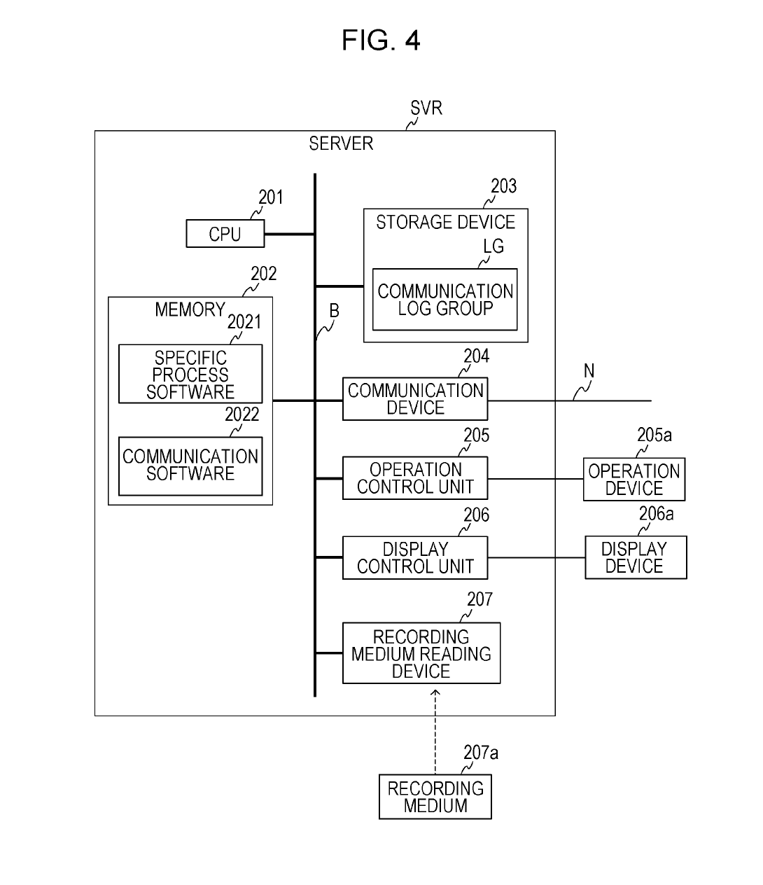

FIG. 4 is a diagram illustrating an example of a configuration of a server, according to an embodiment. FIG. 4 shows a hardware block diagram for various kinds of hardware described with reference to FIGS. 1 to 3. In FIG. 4, a server is illustrated as an example of the various kinds of hardware. Additionally, a fire wall and a switch may have the same configuration as this server.

A server SVR is an example of a device that processes data, and one device of a device group. The server SVR includes a central processing unit (CPU) 201, a memory 202, a storage device 203, a communication device 204, an operation control unit 205, a display control unit 206, and a recording medium reading device 207 which are connected to each other, for example, through a bus B.

The CPU 201 is a computer (control unit) that controls the entirety of the server SVR. The memory 202 temporarily stores data processed in various kinds of information processing which are executed by the CPU 201, or various programs. For example, the storage device 203 is a magnetic storage device such as a hard disk drive (HDD) or a non-volatile memory. The storage device 203 stores a plurality of communication histories to be described later. Hereinafter, a communication history (also, simply referred to as a history) is appropriately described as a communication log, and a plurality of communication logs are appropriately described as a communication log group. In addition, the communication log group is indicated by a symbol LG in FIG. 4.

For example, the communication device 204 is a network interface card (NIC), and is connected to a network N to perform network communication with various devices that are connected to the network N. Additionally, the communication device 204 may be connected to any network among the networks N1 to N6 in accordance with a location at which the server SVR is provided.

In response to an operation instruction that is input from an operation device 205a, the operation control unit 205 executes various processes according to the operation instruction. For example, the operation device 205a is a keyboard or a mouse.

The display control unit 206 executes a process of displaying various images on a display device 206a. Here, for example, the various images are images for setting an IP address and a port number. For example, the display device 206a is a liquid crystal display.

The recording medium reading device 207 is a device that reads out data recorded on a recording medium 207a. For example, the recording medium 207a is a portable recording medium such as a compact disc read only memory (CD-ROM), a digital versatile disc (DVD), and a universal serial bus (USB). In addition, a program (also, referred to software) to be described later may be recorded on the recording medium 207a.

Specific process software 2021 of the memory 202 is software that executes a specific process (function). In a case where the server SVR is a DNS server, the specific process software 2021 executes a so-called DNS function of managing the correlation between a domain name and an IP address. In a case where the server SVR is a mail server, the specific process software 2021 executes an SMTP function or a POP function. In addition, in a case where the server SVR is an image managing server, the specific process software 2021 executes an image managing function.

For example, the communication software 2022 is software that executes TCP/IP communication. The specific process software 2021 executes network communication with software, which is executed by another server or virtual machine, by using the communication software 2022. In a case of executing the communication, the communication software 2022 records various kinds of information which relate to the communication that is executed, and stores the various kinds of information in the storage device 203 as a communication log. The communication log is used when the management device 4 automatically detects a setting error of communication-related information.

For example, it is assumed that the specific process software 2021 communicates with software that operates on another server (not illustrated) by using the communication software 2022. Here, it is assumed that an IP address of the server SVR is “x1.y1.z1.w1”, and a port number that is used by the specific process software 2021 is “p1”. In addition, it is assumed that an IP address that is set to another server is “x2.y2.z2.w2”, and a port number used by software that operates on another server is “p2”.

During system extension, the manager operates the operation device 205a of the server SVR to be extended, and sets the above-described IP address (“x1.y1.z1.w1”) to the server SVR in advance. In addition, the manager operates the operation device 205a of the server SVR and sets the port number (“p2”) of a communication partner to the specific process software 2021 in advance as a transmission destination port number. In addition, the manager operates the operation device 205a of the server SVR, and sets the port number “p1” to the specific process software 2021 in advance in order for the specific process software 2021 to use the port number “p1” as a port number of a transmission source. In addition, during extension of another server, the manager sets the above-described IP address (“x2.y2.z2.w2”) to another server in advance, and sets the port number (“p2”) to specific process software (not illustrated) that is executed by another server in advance.

The communication software 2022 creates a communication packet in which a transmission source IP address is set to “x1.y1.z1.w1”, a transmission source port number is set to “p1”, a transmission destination IP address is set to “x2.y2.z2.w2”, and a transmission destination port number is set to “p2”. In addition, the communication software 2022 includes transmission data. (also, referred to as a payload) in the communication packet, and transmits the transmission data to another server (this transmission is also referred to as data transmission).

The communication software 2022 creates a communication log including the transmission source IP address of “x1.y1.z1.w1”, the transmission source port number of “p1”, the transmission destination IP address of “x2.y2.z2.w2”, and the transmission destination port number of “p2” in combination with the above-described transmission, and stores the communication log in the storage device 203. In this manner, the communication software 2022 records specific information that specifies the transmission source and the transmission destination of communication as the communication log. The communication log is data including the specific information that specifies at least the transmission source and the transmission destination of communication.

In addition, the communication software 2022 establishes a connection with another server before data transmission. When the connection is successfully established, the communication software 2022 includes “OK” in the communication log as a state. On the other hand, in a case where the connection with another server is not established, the communication software 2022 stores “no response” as a state. In addition, in association with the storage of the “no response”, the communication software 2022 stores a communication log including the transmission source IP address of “x1.y1.z1.w1”, the transmission source port number of “p1”, the transmission destination IP address of “x2.y2.z2.w2”, and the transmission destination port number of “p2”. In addition, the communication software 2022 stores the number of times of communication.

Hardware Extension and Operation Verification

Hardware extension will be described in detail with reference to FIGS. 1, 2, and 4. When resource requests increase due to an increase in the number of users of the information processing system SYS, the manager extends hardware, for example, in the above-described subsystem unit.

The subsystem may be the block management server group 21 or the block management server group 23. In this case, the subsystem to be extended is the block management server group 23, and the existing subsystem is the block management server group 21.

During the extension in the subsystem unit, the manager makes a first configuration of the subsystem to be extended be the same or substantially the same as a second configuration of the existing subsystem. The first configuration and the second configuration are set as a hardware configuration and a software configuration. In addition, the hardware is, for example, a server, a network device, or a storage device.

In a case where the first configuration and the second configuration are set as the hardware configuration, a case where the first configuration and the second configuration are the same as each other represents the following case. That is, if the configurations are the same as each other, in a case where the hardware configuration of the existing subsystem is constituted by first to An^{th} servers (An represents an integer of two or more), the hardware configuration of the subsystem to be extended is also constituted by servers having the same function as those of the first to An^{th} servers. In addition, in a case where the first configuration and the second configuration are set as the hardware configuration, a case where the first configuration and the second configuration are substantially the same represents the following case. That is, if the configurations are substantially the same as each other, in a case where the hardware configuration of the existing subsystem is constituted by first to An^{th} servers, the subsystem to be extended has servers having the same function as those of eighty percent of the servers among the first to An^{th} servers.

In a case where the first configuration and the second configuration are set as the software configuration, a case where the first configuration and the second configuration are the same as each other represents the following case. That is, if the configurations are the same as each other, in a case where first software to Bn^{th} software (Bn represent an integer of two or more) operate in respective servers of the existing subsystem, the first software to the Bn^{th} software also operate in respective servers of the subsystem to be extended. In a case where the first configuration and the second configuration are set as the software configuration, a case where the first configuration and the second configuration are substantially the same as each other represents the following case. That is, if the configurations are substantially the same as each other, in a case where first software to the Bn^{th} software operate in respective servers of the existing subsystem, the subsystem to be extended executes eighty percent of the software among the first software to the Bn^{th} software in respective servers of the system. In addition, the numerical value of the above-described eighty percent is illustrative only.

The reason that the manager makes the first configuration and the second configuration be the same or substantially the same as each other is as follows. As a first reason, for example, the manager customizes only a part of various kinds of setting information and the like, which are set in the hardware or the software of the existing subsystem, for the subsystem to be extended, and sets the customized setting information and the like to the hardware or the software of the subsystem to be extended. In other words, the manager utilizes the various kinds of setting information, which are set to the hardware or the software of the existing subsystem, in the subsystem to be extended. Due to the utilization, the manager reduces additional man-hours on the server extension.

In addition, as a second reason, the reason that the manager makes the first configuration and the second configuration be the same or substantially the same as each other is to utilize experience accumulated during management of the existing subsystem in the management of a subsystem to be extended. This experience allows the manager to reduce the burden of managing the subsystem to be extended.

The manager sets the transmission source IP address to a server (that is, a server in the subsystem to be extended) in the second block B 20b during construction, or sets the transmission destination port number, the transmission source port number, and the transmission destination IP address to the specific process software, which operates on the server, in advance.

In a case where the manager extends hardware, and performs various settings on the extended hardware or software that is executed by the hardware, mistakes may be made in the setting of communication-related information.

For example, as described above, when extending the subsystem, the manager utilizes various kinds of setting information, which are set to the hardware or the software of the existing subsystem, in the subsystem to be extended. The various kinds of setting information represent communication-related information such as the IP address and the port number.

During utilization of the communication-related information, the manager partially customizes the IP address or the port number in the communication-related information that is used in the existing subsystem. In addition, the manager sets the IP address or the port number, which is customized, in the hardware or the software of the subsystem to be extended.

For example, the manager may set a different IP address or a different port number with respect to a same functional server in a different management server group so as to cope with individual specifications determined for each block management server group. Thereby, the manager performs customization.

In an example of FIG. 2, the managers may customize an IP address or a port number which is set to the image management server 212 of the first block A 20a, and may set the IP address or the port number, which is customized, to the image management server 232 of the second block B 20b which has the same function as the image management server 212. For example, it is assumed that the manager sets an IP address “12.03.7” to the image management server 212 of the first block A 20a. In this case, the manager sets an IP address “12.4.3.7” obtained by customizing the IP address “12.0.3.7” to the image management server 232 of the second block B 20b which has the same function as the image management server 212.

However, during the process of extending the subsystem, the manager may not appropriately customize the communication-related information such as the IP address, or may forget the customization of the communication-related information, thereby making a setting error in the communication-related information. As a result, the subsystem to be extended (in an example of FIG. 2, the second block B 20b) may not perform appropriate data processing. Accordingly, the manager verifies whether or not the subsystem to be extended appropriately operates before operation of the subsystem to be extended, and corrects the setting error.

Operation Verification

The operation verification of the subsystem to be extended will be described with reference to FIGS. 1, 2, and 4. For example, as the operation verification, the manager allows the second block B 20b to execute a process with the same contents as a process executed by the first block A 20a. Examples of the process executed by the first block A 20a include activation and execution of a virtual machine for a user, and stopping of the virtual machine that is activated.

Specifically, the manager gives an instruction for the image management server 232 of the second block B 20b to activate and execute a virtual machine for operation verification. In response to the instruction, the image management server 232 transmits a communication packet including a command (hereinafter, abbreviated as a command), which instructs transmission of network information for activating and executing the virtual machine for operation verification, to the network management server 233. The network management server 233 transmits the network information to the image management server 232 in response to the command. Similarly, the image management server 232 transmits a command, which instructs transmission of storage information for activating and executing a virtual machine for operation verification, to the storage management server 234. The storage management server 234 transmits the storage information to the image management server 232 in response to the command.

The image management server 232 transmits information for activating a VM that is managed by the server, and the network information and storage information which are received, to the VM server 242 of the user server group 24 together with the VM activation command. In response to the VM activation command, the VM server 242 activates and executes a virtual machine that corresponds to the VM activation information, the network information, and the storage information which are received. The manager executes various kinds of information processing with respect to the virtual machine that is activated and executed by the VM server 242 to confirm whether or not an appropriate operation is performed.

When this confirmation is completed, the manager gives an instruction for the image management server 232 of the second block B 20b to stop the virtual machine for operation verification. In response to the instruction, the image management server 232 transmits a command that instructs the stoppage of the virtual machine for operation verification to the VM server 242. In response to the command, the VM server 242 stops the virtual machine. In accordance with transmission and reception of the command and the like between the above-described respective servers, the respective servers create a communication log and store the communication log in the servers.

In a case where correct communication-related information is set to the hardware or the software of the second block B 20b, communication between servers is appropriately executed during verification. However, in a case where correct communication-related information is not set to the hardware or the software of the second block B 20b, the communication between the servers is not appropriately executed.

For example, it is assumed that software (specific process software) of the image management server 232 communicates with the network management server 233. In this case, during extension of the second block B 20b, the manager is demanded to correctly set communication-related information for the network management server 233, which is a communication destination, to the software of the image management server 232. Examples of the above-described communication-related information include an IP address of the network management server 233 that is a communication destination, and a port number for a service that is executed by the network management server 233. In a case where the correct communication-related information is not set to the image management server 232, it is difficult for the image management server 232 to execute communication with respect to the network management server 233. As a result, activation and execution of the above-described virtual machine are not performed, and thus operation verification of the second block B 20b ends in failure. When the operation verification ends in failure, the manager analyzes the cause of the failure of the operation verification.

A hardware configuration and a software configuration of the second block B 20b that is an operation verification target are the same or substantially the same as a hardware configuration and a software configuration of the first block A 20a to which the operation verification is already executed and which appropriately operates. In addition, the manager partially customizes the communication-related information that is set to a server of the first block A 20a and sets the customized communication-related information to a server of the second block B 20b.

Here, in a case where the second block B 20b executes a process with the same contents as a process executed by the first block A 20a as the operation verification, it is assumed that a communication process appropriately operates in the second block B 20b that is an operation verification target. Under this assumption, it may be assumed that a communication log, which matches or substantially matches a communication log present in the first block A 20a in which the operation verification is completed, is likely to be present in the second block B 20b that is an operation verification target.

In this regard, the present inventors have found that a setting error is likely to be present in communication-related information that relates to a communication log present only in a first device group (for example, the first block A 20a) in which the operation verification is completed.

In addition, the present inventors have obtained the following finding. Among communication logs present in a second device group (for example, the second block B 20b) that is an operation verification target, even when a communication log that matches a communication log present in the first device group in which the operation verification is completed is present, a setting error is likely to be present in communication-related information that relates to the communication log. As the reason, as described below, a case in which a communication process is accidentally successful may be exemplified.

In addition, among communication logs in the second block B 20b that is an operation verification target, a communication log (communication state information: no response) that indicates a communication failure may be recorded. In the communication log, a setting error is also likely to be present in communication-related information that relates to the communication log. Hereinafter, the communication log in which a setting error is likely to be present in the communication-related information is appropriately described as a setting error candidate communication log.

Accordingly, during the operation verification, the management device 4 compares a communication log present in the first device group in which the operation verification is completed and a communication log present in the second device group that is an operation verification target with each other. The management device 4 detects a setting error candidate communication log based on a comparison result. The management device 4 determines that a setting error occurs with respect to the communication-related information that relates to the detected setting error candidate communication log, and the management device 4 notifies the manager of the determination. The comparison of the communication log, and the detection and notification of the setting error which are executed by the management device 4 will be described below in detail.

### First Embodiment of Management Device

Hardware Block Diagram of Management Device

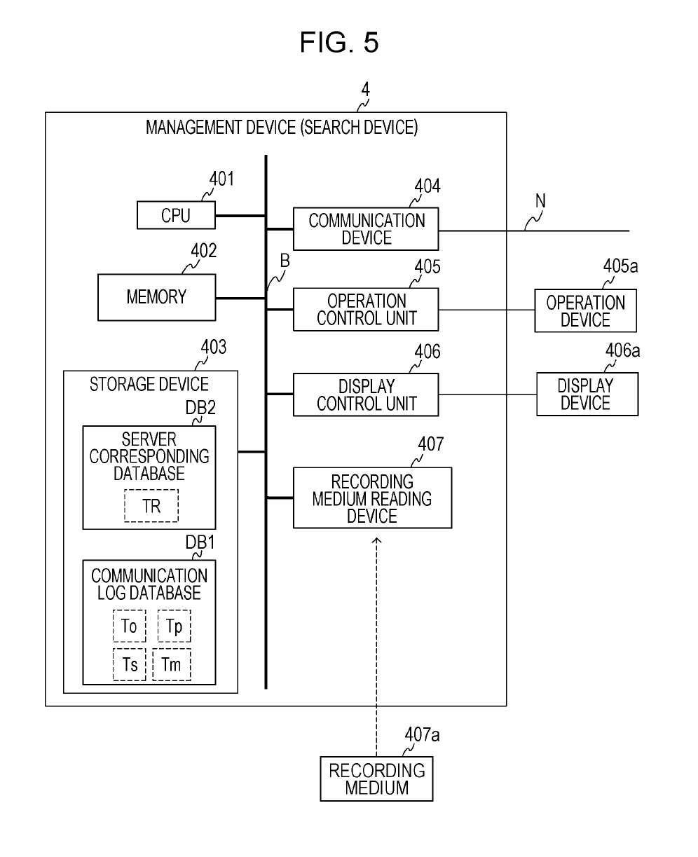

FIG. 5 is a diagram illustrating an example of a hardware configuration of a management device, according to an embodiment. The management device 4 of FIG. 1 includes a CPU 401, a memory 402, a storage device 403, a communication device 404, an operation control unit 405, a display control unit 406, and a recording medium reading device 407 which are connected to each other, for example, via a bus B.

The CPU 401 is a computer (control unit) that controls the entirety of the management device 4. The memory 402 temporarily stores data processed in various kinds of information processing which are executed by the CPU 401, or various programs. For example, the storage device 403 is a magnetic storage device such as a hard disk drive or a non-volatile memory. The storage device 403 stores a communication log database DB1 and a server-corresponding database DB2 to be described later.

For example, the communication device 404 is a network interface card, and is connected to a network N to perform network communication with various devices that are connected to the network N.

In response to an operation instruction that is input from an operation device 405a, the operation control unit 405 executes various processes according to the operation instruction. For example, the operation device 405a is a keyboard or a mouse.

The display control unit 406 executes a process of displaying various images on a display device 406a. Here, for example, the various images are images including various kinds of information which relate to a setting error. For example, the display device 406a is a liquid crystal display.

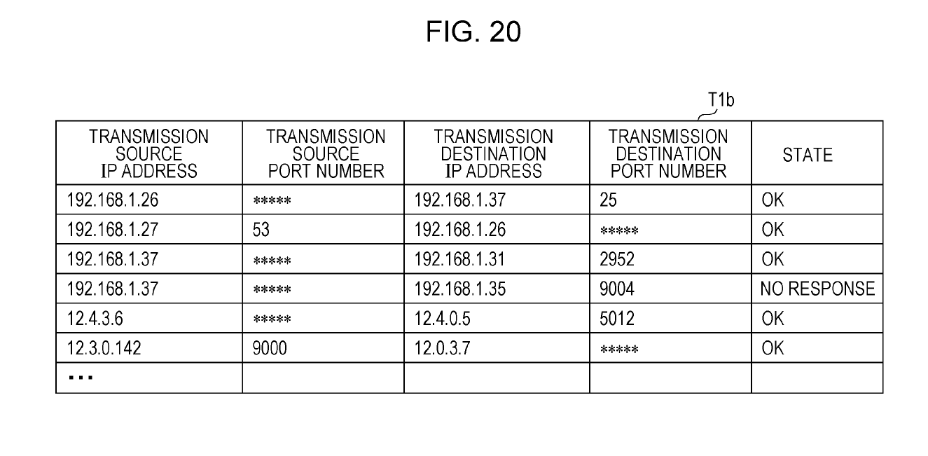

The recording medium reading device 407 is a device that reads out data recorded on a recording medium 407a. For example, the recording medium 407a is a portable recording medium such as a CD-ROM, a DVD, and a USB memory. In addition, a program to be described with reference to FIG. 19 may be recorded on the recording medium 407a.

Block Diagram of Software Module of Management Device

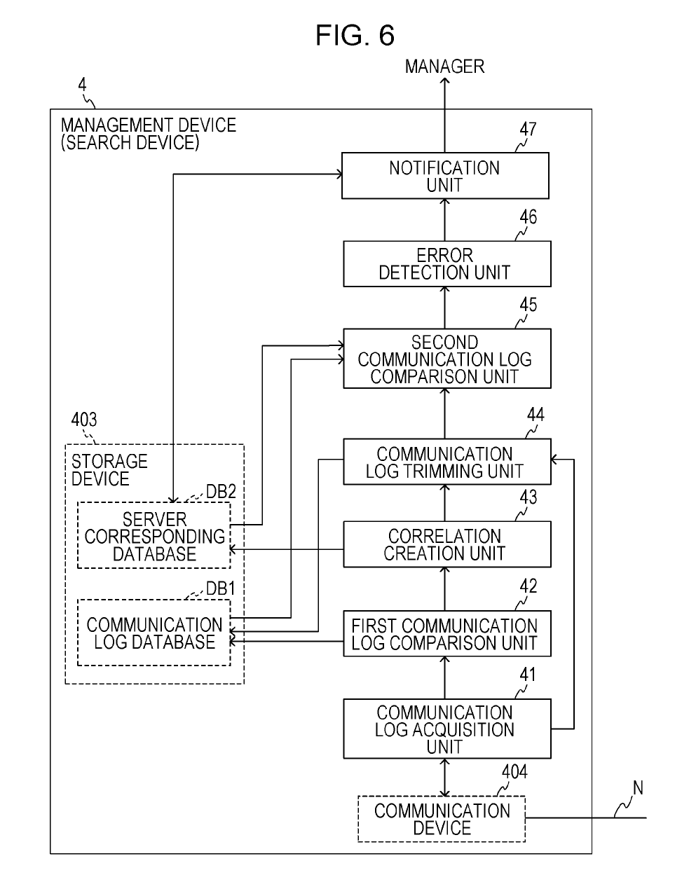

FIG. 6 is a diagram illustrating an example of a functional configuration of a management device, according to an embodiment. FIG. 6 shows a block diagram of a software module of the management device 4 in FIG. 5. In the management device 4 of FIG. 6, the storage device 403 and the communication device 404, which are hardware elements, are drawn with a dotted line.

The management device 4 is an example of a device that detects a setting error of specific information that specifies a transmission source and a transmission destination of communication in the information processing system SYS (refer to FIG. 1) in which the first device group and the second device group are connected to each other through a network. Here, the specific information includes IP addresses of the transmission source and the transmission destination, and port numbers of the transmission source and the transmission destination.

To detect and make a notification of the setting error of the above-described specific information, the management device 4 includes a communication log acquisition unit 41, a first communication log comparison unit 42, a correlation creation unit 43, a communication log trimming unit 44, a second communication log comparison unit 45, an error detection unit 46, and a notification unit 47.

The communication log acquisition unit 41 acquires a first communication log including specific information that specifies a transmission source and a transmission destination of communication that is executed between devices (for example, servers) of the block management server group 21 in the first device group (for example, the first block A 20a) in which the operation verification is completed. In addition, the communication log acquisition unit 41 acquires a second communication log including specific information that specifies a transmission source and a transmission destination of communication that is executed between servers of the block management server group 23 in the second device group (for example, the second block B 20b) that is an operation verification target. In addition, as described with reference to FIG. 4, the second communication log includes communication state information indicating that network communication is normally executed (communication state: “OK”) or the network communication is not normally executed (“no response”).

The first communication log comparison unit 42 compares the first communication log and the second communication log with each other, and searches for a server in the first device group and a server in the second device group, which are same functional servers, based on a comparison result. The search is also called determination. Hereinafter, the search is appropriately described as “determination”.

Here, the first and second communication logs include a transmission source IP address that is set to a server of the transmission source of the above-described communication, and a transmission destination IP address and a transmission destination port number which are set to a server of the transmission destination of the above-described communication.

In the above-described comparison, the first communication log comparison unit 42 compares the transmission destination port number of the first communication log and the transmission destination port number of the second communication log with each other, and determines whether or not the transmission destination port number of the first communication log and the transmission destination port number of the second communication log match each other.

In the above-described search, the first communication log comparison unit 42 searches for a same functional server based on a transmission source IP address and a transmission destination IP address of a first communication log that includes a matching transmission destination port number, and a transmission source IP address and a transmission destination IP address of a second communication log that includes the matching transmission destination port number.

The correlation creation unit 43 stores the IP address that is set to the same functional server in the first device group and the IP address that is set to the same functional server in the second device group in the server-corresponding database DB2 of the storage device 403 in association with each other.

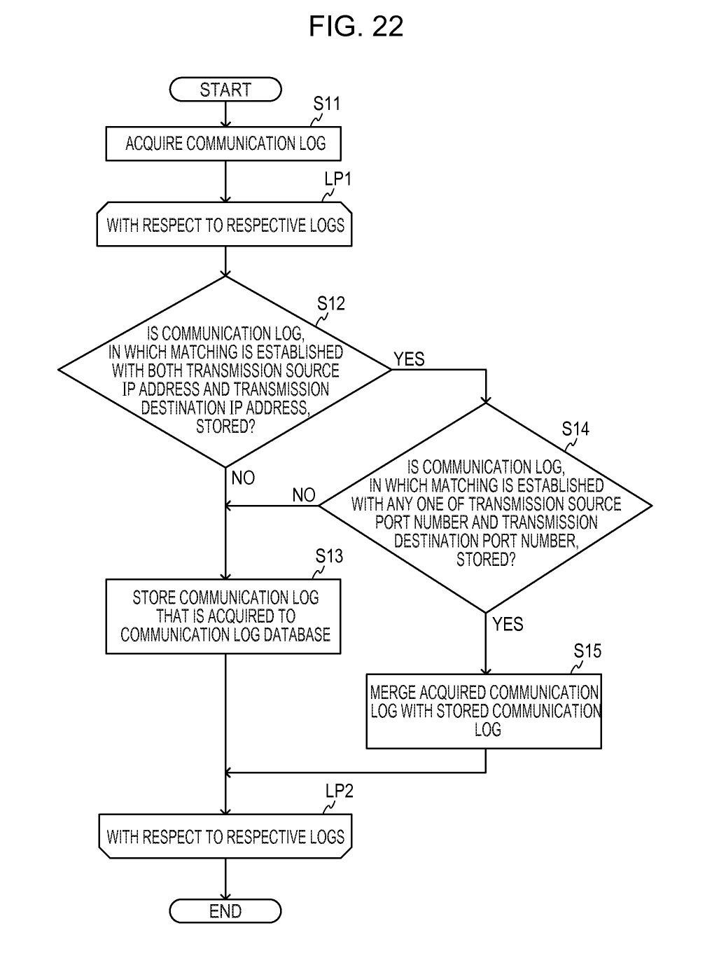

The communication log trimming unit 44 trims the first and second communication logs that are acquired by the communication log acquisition unit 41 to reduce a storage amount in the communication logs, and stores the first and second communication logs. The second communication log comparison unit 45 compares first specific information of the first communication log and second specific information of the second communication log with each other, which corresponds to the first communication log, with reference to, for example, a server-corresponding table TR2 (refer to FIG. 21).

The error detection unit 46 detects a setting error of specific information that is set to a device (for example, a server) of the second device group based on a comparison result between the above-described first specific information and the above-described second specific information. The notification unit 47 notifies the manager of the setting error detected by the error detection unit 46 through the display control unit 406 and the display device 406a (refer to FIG. 5).

The communication log acquisition unit 41, the first communication log comparison unit 42, the correlation creation unit 43, the communication log trimming unit 44, the second communication log comparison unit 45, the error detection unit 46, and the notification unit 47 are so-called programs. The programs are stored, for example, in the storage device 403. During activation, the CPU 401 in FIG. 5 reads out the programs from the storage device 403, and develops the programs in the memory 402, thereby allowing the programs to function as a software module.

Same Functional Server

The second communication log comparison unit 45 compares the first communication log present in the first device group in which the operation verification is completed and the second communication log present in the second device group that is an operation verification target with each other, and determines whether or not the first and second communication logs have the same contents. In the immediately previous stage of the comparison, the second communication log comparison unit 45 compares the IP address that is included in the first communication log and the IP address that is included in the second communication log with each other, and determines whether or not both of the IP addresses match each other.

In a case of determining whether or not the first and second communication logs have the same contents, when the IP address set to the device of the first device group in which the operation verification is completed, and the IP address set to the device of the second device group which has the same function as the device in the first device group and which is an operation verification target correspond one to one, the above-described determination may be performed with high accuracy. For example, the one-to-one correspondence between the IP address set to the device of the first device group in which the operation verification is completed and the IP address set to the device of the second device group which is an operation verification target represents that both of the IP addresses match each other.

However, as described above, the manager sets various kinds of setting information (for example, an IP address), which are customized, and the like to the device of the second device group which is an operation verification target. That is, the IP address set to the device of the first device group in which the operation verification is completed, and the IP address set to the device (for example, a server) of the second device group which has the same function as the device of the first device group and which is an operation verification target may not match each other.

Therefore, the second communication log comparison unit 45 executes the following process of converting an IP address in order for the IP address set to the device of the first device group in which the operation verification is completed and the IP address set to the device of the second device group which has the same function as the device of the first device group and which is an operation verification target set, to correspond one to one.

For execution of the process of converting the above-described IP address, the same functional server of the first device group in which the operation verification is completed and the same functional server of the second device group which is an operation verification target are determined (also, referred to as search). That is, it is desirable for the management device 4 to determine the same functional server. In addition, the same functional server is also called a server having substantially the same role.

Hereinafter, the process of determining the same functional server will be described. Here, as a premise for the execution of the process of determining the same functional server, the following three assumptions are assumed. As a first assumption, the number of servers of the first block A 20a in which the operation verification is completed and the number of servers of the second block B 20b which is an operation verification target may not match each other. In addition, in this non-matching case, a server that is not determined to be the same functional server remains in any one or both of the first block A 20a and the second block B 20b.

As a second assumption, the same functional server is desirable to be present in the first block A 20a and the second block B 20b. However, a plurality of the same functional servers may be present in any one or both of the first block A 20a and the second block B 20b. For example, Na (Na represents an integer of two or more) servers having a function may be present in the first block A 20a, and Nb (Nb represents an integer different from Na) servers having the same function as the function may be present in the second block B 20b.

As a third assumption, a setting error of specific information set to the server of the first block A 20a in which the operation verification is completed is not present (correction of the setting error is completed), but a setting error of specific information set to the server of the second block B 20b which is an operation verification target is present.

However, a port number included in a communication log is a number that specifies an application (also, referred to as a program, a service, and a component) that operates on a server that is a communication destination when an information processing device such as a server executes communication. In addition, a different port number is allocated for each application operating on the server that is a communication destination.

Here, it is assumed that one application executes one function. In this case, it is possible to discriminate a function of a server that allows one application to operate due to one port number that is allocated to the one application. In other words, it is possible to specify a function executed by the server by the port number. For example, it may be seen that a server allowing an application to which one port number 53 is allocated to operate is a DNS server that executes a DNS function.

Accordingly, in a case where a port number allocated to an application that operates on a first server of the first block A 20a in which the operation verification is completed, and a port number allocated to an application that operates on a second server of the second block B 20b which is an operation verification target match each other, the following determination process is executed. That is, the first communication log comparison unit 42 determines servers, which operate as the first and second servers, to be same functional servers.

Flow of Process of Determining Same Functional Server

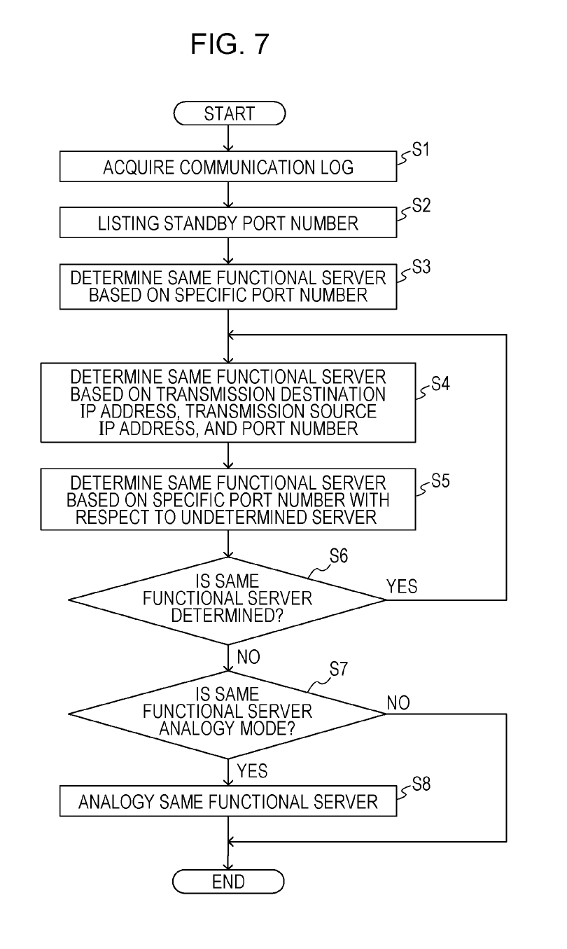

FIG. 7 is a diagram illustrating an example of an operational flowchart for a process of determining a same functional server, according to an embodiment.

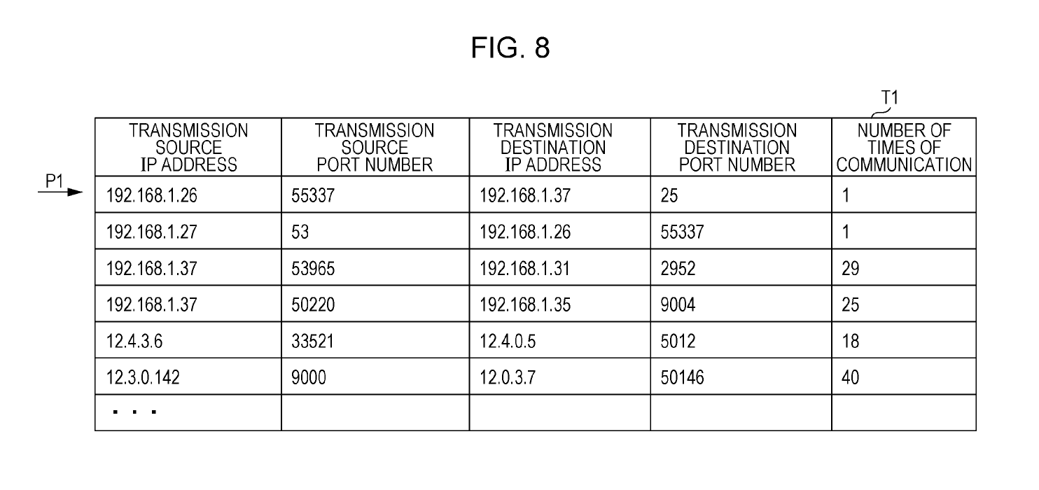

Step 51: The communication log acquisition unit 41 acquires a communication log of the first device group in which the operation verification is completed, or a communication log of the second device group that is an operation verification target. Step S1 will be described with reference to FIG. 8.

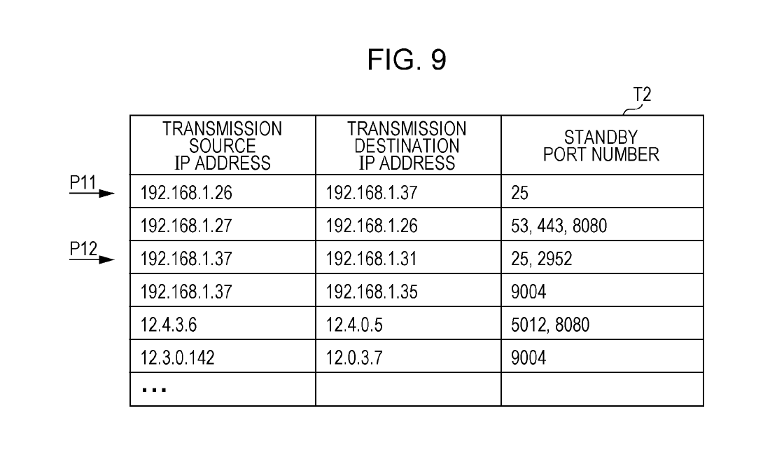

Step S2: The first communication log comparison unit 42 performs listing of a standby port number. Step S2 will be described with reference to FIG. 9.

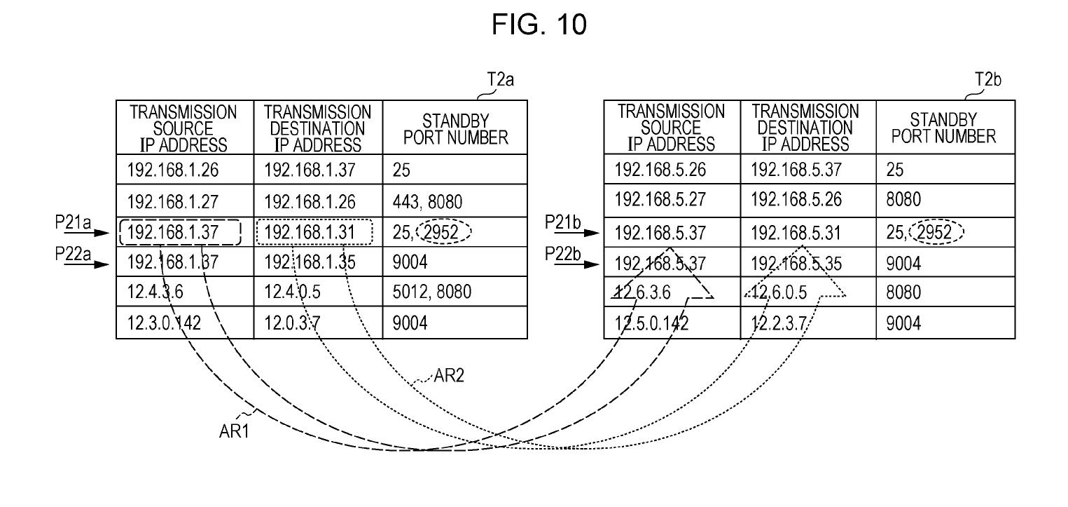

Step S3: The first communication log comparison unit 42 determines a same functional server based on a specific port number. A process in step S3 is also called a process of determining a same functional server by application of a single-use port rule. Step S3 will be described with reference to FIG. 10.

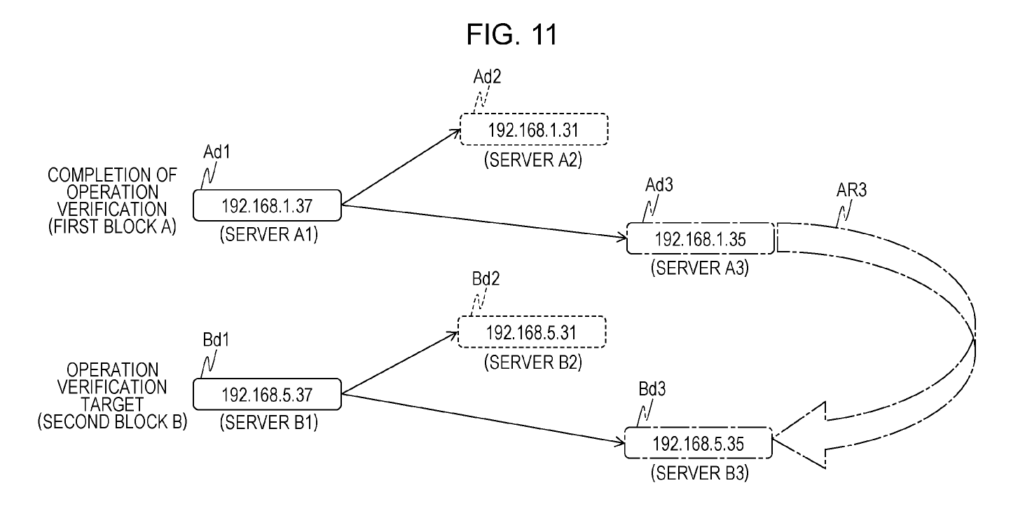

Step S4: The first communication log comparison unit 42 determines a same functional server based on a transmission destination IP address, a transmission source IP address, and a port number. A process in step S4 is also called a process of determining a same functional server by application of a rule in which transmission source correlation is completed. Step S4 will be described with reference to FIG. 11.

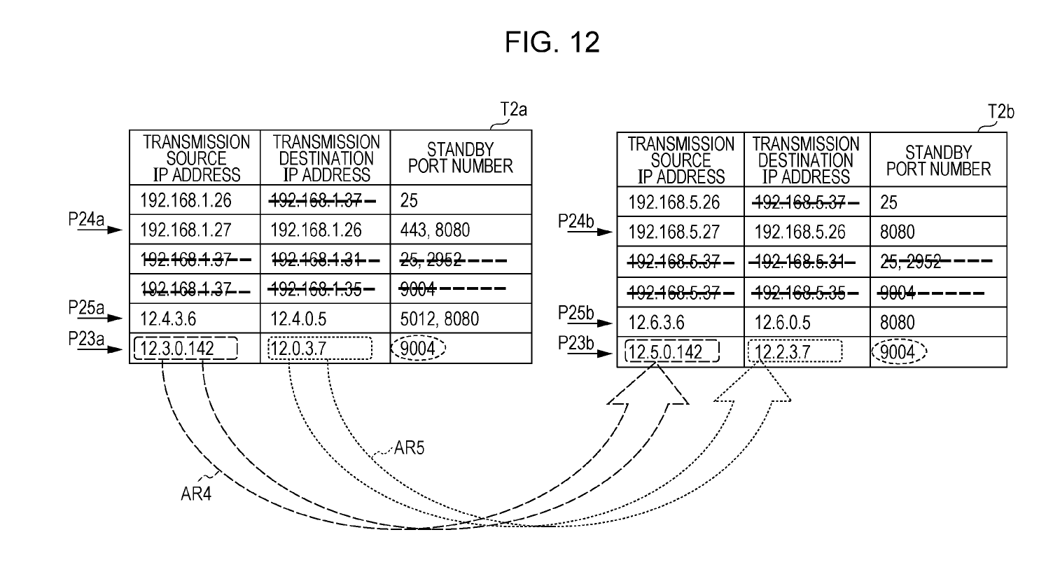

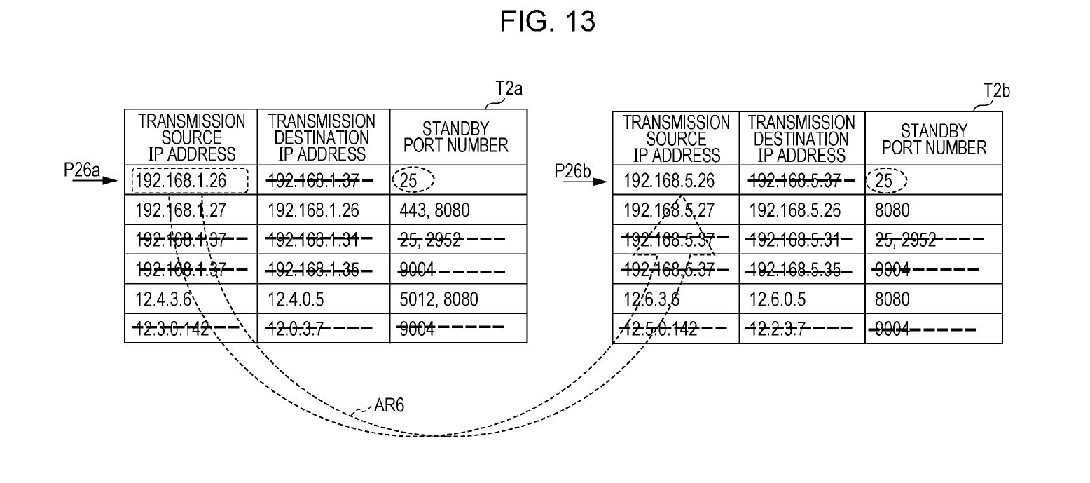

Step S5: The first communication log comparison unit 42 determines a same functional server based on a specific port number with respect to an undetermined server. A process in step S5 is also called a process of determining a same functional server by application of a remaining single-use port rule. Step S5 will be described with reference to FIGS. 12 and 13.

Step S6: The first communication log comparison unit 42 determines whether or not a same functional server is determined in step S4 and step S5, and in a case where the same functional server is determined (YES in step S6), the process returns again to step S4. On the other hand, in a case where the first communication log comparison unit 42 does not determine the same functional server (NO in step S6), the process transitions to step S7.

Step S7: The first communication log comparison unit 42 determines whether or not a same functional server analogy mode is “ON”. The same functional server analogy mode is a mode in which the same functional server is analogized by using a standby port number in a case where the same functional server is not determined even when executing the processes in step S3 to step S5. The case where the same functional server analogy mode is “ON” represents a case where a same functional server analogy flag that is stored in the storage device 403 is “ON”. The manager operates the operation device 405a to set “ON” (for example, “1”) or “OFF” (for example, “0”) to the same functional server analogy flag that is stored in the storage device 403.

In a case where the same functional server analogy mode is “OFF” (NO in step S7), the process is terminated. In a case where the same functional server analogy mode is “ON” (YES in step S7), the process transitions to step S8.

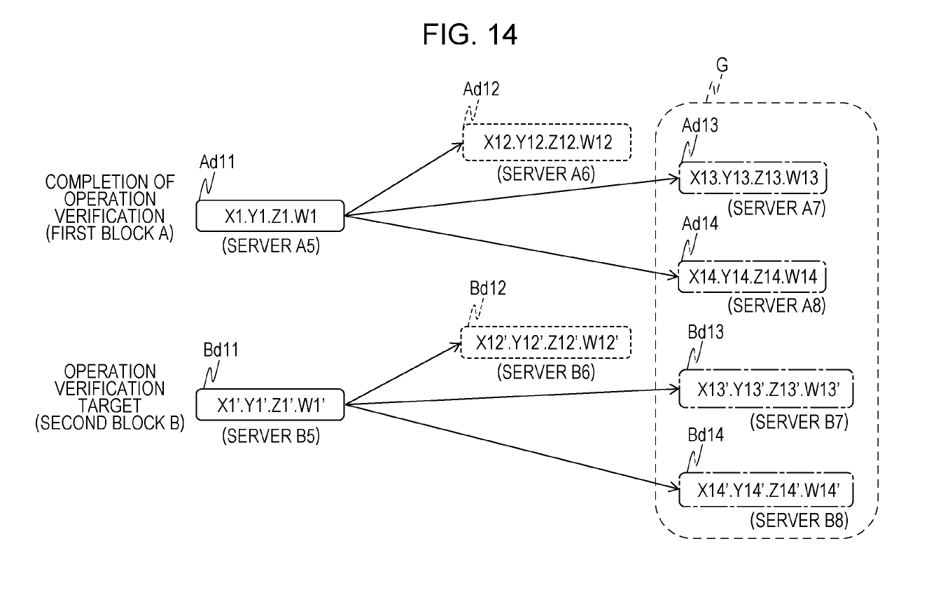

Step S8: The first communication log comparison unit 42 analogizes the same functional server. Step S8 will be described with reference to FIGS. 14 to 17.

Hereinafter, the contents of respective steps in FIG. 7 will be described in detail with reference to FIGS. 8 to 17.

Acquisition of Communication Log

The communication log acquisition unit 41 acquires a communication log of the first device group in which the operation verification is completed, or a communication log of the second device group that is an operation verification target, and outputs the communication log to the first communication log comparison unit 42 and the communication log trimming unit 44 (step S1).

Specifically, the communication log acquisition unit 41 acquires a communication log of the first block A 20a in which the operation verification is completed, or a communication log of the second block B 20b that is an operation verification target. The communication log acquisition unit 41 outputs the acquired communication log to the communication log trimming unit 44 and the first communication log comparison unit 42. Before operational verification of the second block B 20b, the communication log acquisition unit 41 acquires a non-acquired communication log from a communication log group (refer to a symbol LG in FIG. 4) that is stored in a storage device of a server included in the first block A 20a in which the operation verification is completed. In addition, during the operation verification, the communication log acquisition unit 41 acquires a non-acquired communication log from a communication log group (refer to a symbol LG in FIG. 4) that is stored in a storage device of a server included in the second block B 20b that is an operation verification target.

The first communication log comparison unit 42 stores the communication log of the first block A 20a or the communication log of the second block B 20b which is input from the communication log acquisition unit 41 to the communication log database DB1 in FIG. 5.

FIG. 8 is a diagram illustrating an example of a first table indicating a communication log database, according to an embodiment. The communication log table T1 is an example of a table that stores the communication log that is acquired by the management device 4 from the first block A 20a. A state in which the communication log database DB1 in FIG. 5 stores the communication log table T1 is illustrated by a symbol To in FIG. 5.

The communication log table T1 includes a transmission source IP address column, a transmission source port number column, a transmission destination IP address column, a transmission destination port number column, and a column of the number of times of communication. In the communication log table T1, one communication log is stored for each row.

As described above, the communication log includes the transmission source IP address, the transmission source port number, the transmission destination IP address, the transmission destination port number, and the number of times of communication.

For example, the first communication log comparison unit 42 stores a communication log including a transmission source IP address “192.168.1.26”, a transmission source port number “55337”, a transmission destination IP address “192.168.1.37”, a transmission destination port number “25”, and the number of times of communication “1” being executed between servers in the first block A 20a in the communication log table T1 (refer to a symbol P1).

The first communication log comparison unit 42 also stores a communication log of the second block B 20b, which is input from the communication log acquisition unit 41, in the storage device 403 in the table type illustrated in FIG. 8. In addition, the first communication log comparison unit 42 stores the communication log of the first block A 20a and the communication log of the second block B 20b in separate tables.

Listing of Standby Port Number

The first communication log comparison unit 42 makes a list of a standby port number (step S2). The standby port number will now be described. As described with reference to FIG. 4, it is assumed that the specific process software 2021 that is executed by a first server SVR communicates with software that operates on a second server (not illustrated) by using the communication software 2022. Here, an IP address of the server SVR is “x1.y1.z1.w1”, and a port number that is used by the specific process software 2021 is “p1”. In addition, an IP address that is set to a second server is “x2.y2.z2.w2”, and a port number used by software that operates on the second server is “p2”.

The communication software 2022 creates a communication packet (hereinafter, appropriately described as a communication packet P) in which a transmission source IP address is set to “x1.y1.z1.w1”, a transmission source port number is set to “p1”, a transmission destination IP address is set to “x2.y2.z2.w2”, and a transmission destination port number is set to “p2”. In addition, the communication software 2022 includes transmission data in the communication packet P, and transmits the transmission data to the second server.

The standby port number in the above-described communication is the port number “p2” that is used by software operating on the second server that is a transmission destination of the communication packet.

The first communication log comparison unit 42 extracts a standby port number with respect to all communication logs acquired from the first block A 20a and the second block B 20b, and extracts transmission source IP addresses and transmission destination IP addresses which are included in communication logs including the standby port number that is extracted. In addition, the first communication log comparison unit 42 stores the transmission source IP address and the transmission destination IP address, which are extracted, in association with the standby port number that is extracted.

The process of storing the transmission source IP address and the transmission destination IP address, which are extracted in association with the standby port number that is extracted, by the first communication log comparison unit 42 is the listing of the standby port number.

For example, the first communication log comparison unit 42 performs the listing of the standby port number with respect to all communication logs that are stored in the communication log table T1 in FIG. 8. In a case of the communication log indicated by a symbol P1 in FIG. 8, the standby port number is “25” that is a transmission destination port number stored in the transmission destination port number column.

The first communication log comparison unit 42 extracts the transmission destination port number “25” as a standby port number from a communication log P1, and extracts the transmission source IP address “192.168.1.26” and the transmission destination IP address “192.168.1.37” which are included in the communication log P1. In addition, the first communication log comparison unit 42 stores the transmission source IP address “192.168.1.26” and the transmission destination IP address “192.168.1.37” in association with the standby port number “25”, for example, in a table.

It is possible to specify a function of a server to which the standby port number is set by using the standby port number.

Hereinafter, a log, which includes the standby port number that is extracted, and the transmission source IP address and the transmission destination IP address which are extracted and which correspond to the standby port number, are appropriately described as a standby port number log.

FIG. 9 is a diagram illustrating an example of a table indicating a state in which standby port numbers are listed, according to an embodiment. A port number table T2 includes a transmission source IP address column, a transmission destination IP address column, and a standby port number column. A symbol P11 represents a standby port number log that is extracted by the first communication log comparison unit 42 from the communication log P1 in FIG. 8.

The first communication log comparison unit 42 stores the standby port number “25” that is extracted as described above in the standby port number column, and respectively stores the transmission source IP address “192.168.1.26” and the transmission destination IP address “192.168.1.37” in the transmission source IP address column and the transmission destination IP address column in association with the standby port number “25”.

Then, the first communication log comparison unit 42 performs listing of the standby port number with respect to all communication logs from the first block A 20a, and stores the standby port number, for example, in the port number table T2 in FIG. 9.

Here, the first communication log comparison unit 42 stores standby port number logs having the same transmission source IP address and the same transmission destination IP address, among a plurality of the standby port number logs, in the same row of the port number table.

For example, a transmission source IP address “192.168.1.37”, a transmission destination IP address “192.168.1.31”, and a standby port number “25” are included in a first standby port number log. In addition, a transmission source IP address “192.168.1.37”, a transmission destination IP address “192.168.1.31”, and a standby port number “2952” are included in a second standby port number log. In this case, as indicated by a symbol P12 in FIG. 9, the first communication log comparison unit 42 stores the first and second standby port number logs in the same row. Specifically, the first communication log comparison unit 42 stores the transmission source IP address “192.168.1.37” in a cell in which a row indicated by a symbol P12 and the transmission source IP address column intersect each other. In addition, the first communication log comparison unit 42 stores the transmission destination IP address “192.168.1.31” in a cell in which the row indicated by the symbol P12 and the transmission destination IP address column intersect each other. In addition, the first communication log comparison unit 42 stores the port numbers “25” and “2952” in a cell in which the row indicated by the symbol P12 and the standby port number column intersect each other.

The first communication log comparison unit 42 creates a standby port number log from the communication log of the first block A 20a, and stores the standby port number log in the communication log database DB1 in the table type illustrated in FIG. 9. In addition, the first communication log comparison unit 42 creates a standby port number log from the communication log of the second block B 20b, and stores the standby port number log in the communication log database DB1, for example, in the table type illustrated in FIG. 9.

FIG. 10 is a diagram illustrating an example of a table storing standby port number logs created from communication logs of first and second blocks, according to an embodiment.

A port number table T2a is an example of a table that stores the standby port number log that is created from the communication log of the first block A 20a. A port number table T2b is an example of a table that stores the standby port number log that is created from the communication log of the second block B 20b. A state in which the communication log database DB1 in FIG. 5 stores the port number table T2a and the port number table T2b is indicated by a symbol Tp in FIG. 5. Then, the first communication log comparison unit 42 determines a same functional server with reference to the port number table T2a and the port number table T2b.

Determination of Same Functional Server Based on Specific Port Number

The first communication log comparison unit 42 determines a same functional server based on a specific port number (step S3).

Specifically, the first communication log comparison unit 42 determines whether or not one matching transmission destination port number is present among transmission destination port numbers of one or more first communication logs and transmission destination port numbers of one or more second communication logs. For example, each of the first communication logs is a communication log of the first block A 20a, and each of the second communication log is a communication log of the second block B 20b.

In a case where it is determined that one matching transmission destination port number is present, the first communication log comparison unit 42 executes the following process. That is, the first communication log comparison unit 42 determines (searches for) a server to which a transmission source IP address of the first communication log including the matching transmission destination port number is set, and a server to which a transmission source IP address of the second communication log including the matching transmission destination port number is set as a same functional server. In addition, the first communication log comparison unit 42 determines a server to which a transmission destination IP address of the first communication log including the matching transmission destination port number is set, and a server to which a transmission destination IP address of the second communication log including the matching transmission destination port number is set as a same functional server.

For example, in a case where only one unit of communication using an arbitrary specific port number is present in the first block A 20a, and only one unit of communication using the arbitrary specific port number is present in the second block B 20b (this case is described as a first case), the first communication log comparison unit 42 performs the following determination. That is, in the first case, the first communication log comparison unit 42 determines a server, to which a transmission source IP address included in a communication log of the one unit of communication is set, in the first block A 20a, and a server, to which the transmission source IP address included in the communication log of the one unit of communication is set, in the second block B 20b as a same functional server. In addition, in the first case, the first communication log comparison unit 42 determines a server, to which a transmission destination IP address included in the communication log of the one unit of communication is set, in the first block A 20a, and a server, to which the transmission destination IP address included in the communication log of the one unit of communication is set, in the second block B 20b as a same functional server.

In other words, the first case represents a case where only one same standby port number is stored in the standby port number column of the port number table T2a in FIG. 10, and in the standby port number column of the port number table T2b in FIG. 10. In the example of FIG. 10, a standby port number “2952” surrounded by a dotted-line circle is the same standby port number in the first case.

In the first case, the first communication log comparison unit 42 determines a server to which a transmission source IP address of a standby port number log including the same standby port number in the port number table T2a is set, and a server to which a transmission source IP address of a standby port number log including the same standby port number in the port number table T2b is set as a same functional server.

In a case of the above-described example, a server to which a transmission source IP address “192.168.137” of the standby port number log including the port number “2952” in the port number table T2a is set, and a server to which a transmission source IP address “192.168.5.37” of the standby port number log including the port number “2952” in the port number table T2b is set are determined to be same functional servers (refer to a symbol AR1).

In addition, in the first case, the first communication log comparison unit 42 determines a server to which a transmission destination IP address of the standby port number log including the same standby port number in the port number table T2a is set, and a server to which a transmission destination IP address of the standby port number log including the same standby port number in the port number table T2b is set as a same functional server.

In a case of the above-described example, a server to which a transmission destination IP address “192.168.1.31” of the standby port number log including the port number “2952” in the port number table T2a is set, and a server to which a transmission destination IP address “192.168.5.31” of the standby port number log including the port number “2952” in the port number table T2b is set are determined to be same functional servers (refer to a symbol AR2).

Determination of Same Functional Server Based on Transmission Destination IP Address, Transmission Source IP Address, and Port Number

The first communication log comparison unit 42 determines a same functional server based on the transmission destination IP address, the transmission source IP address, and the port number (step S4). In addition, a specific example thereof will be described with reference to FIG. 11.

During execution of step S4, with reference to a plurality of first communication logs, the first communication log comparison unit 42 determines whether or not among a plurality of servers that are communication destinations with which a server determined (searched for) as a same functional server in the first device group communicates, one first server not determined to be a same functional server is present. For example, the first device group is the first block A 20a.

In addition, with reference to a plurality of second communication logs, the first communication log comparison unit 42 determines that among a plurality of servers that are communication destinations with which a server determined to be a same functional server in the second device group communicates, one second server not determined to be a same functional server is present. For example, the second device group is the second block B 20b.

In a case where it is determined that one first server is present and one second server is present, the first communication log comparison unit 42 performs the following determination. That is, the first communication log comparison unit 42 determines whether or not a transmission destination port number (standby port number) of the first communication log including an IP address set to one first server as a transmission destination IP address, and a transmission destination port number of the second communication log including an IP address set to one second server as a transmission destination IP address match each other.

In addition, in a case where it is determined that the transmission destination port numbers match each other, the first communication log comparison unit 42 determines one first server and one second server to be same functional servers.

For example, in a case (described as a second case) where the following first to third conditions are satisfied, the first communication log comparison unit 42 performs the following determination. First, the first to third conditions will be described.

The first condition assumes that a server of the first block A 20a and a server of the second block B 20b are determined to be same functional servers.

The second condition assumes that among a plurality of transmission destination (communication destination) servers to which a communication packet is transmitted by the determined server, only one server not determined to be a same functional server is present. Hereinafter, a server that is not determined to be the same functional server is appropriately described as an undetermined server.

The third condition assumes that a port number (that is, a standby port number) that is used by software operating on the one undetermined server in the first block A 20a, and a standby port number that is used by software operating on the one undetermined server in the second block B 20b are the same as each other.

In a case where the first to third conditions are satisfied, the first communication log comparison unit 42 determines the one undetermined server in the first block A 20a and the one undetermined server in the second block B 20b to be same functional servers.

FIG. 11 is a diagram illustrating an example of determination of a same functional server based on a transmission destination IP address, a transmission source IP address, and a port number, according to an embodiment. In FIG. 11, a solid-line arrow schematically illustrates transmission of a communication packet. The first to third conditions will be described with reference to FIGS. 10 and 11.

As can be seen from a symbol P21a in FIG. 10, a server (hereinafter, described as a server A1), to which an IP address “192.168.1.37” (refer to a symbol Ad1 in FIG. 11) is set, transmits a communication packet to a server (hereinafter, described as a server A2) to which an IP address “192.168.1.31” (refer to a symbol Ad2 in FIG. 11) is set. In addition, as can be seen from a symbol P22a in FIG. 10, the server Al transmits a communication packet to a server (hereinafter, described as a server A3) to which an IP address “192.168.1.35” (refer to a symbol Ad3 in FIG. 11) is set.

As can be seen from a symbol P21b in FIG. 10, a server (hereinafter, described as a server B1), to which an IP address “192.168.5.37” (refer to a symbol Bd1 in FIG. 11) is set, transmits a communication packet to a server (hereinafter, described as a server B2) to which an IP address “192.168.5.31” (refer to a symbol Bd2 in FIG. 11) is set. In addition, as can be seen from a symbol P22b in FIG. 10, the server B1 transmits a communication packet to a server (hereinafter, described as a server B3) to which an IP address “192.168.5.35” (refer to a symbol Bd3 in FIG. 11) is set.

In addition, as is apparent from the port number table T2a in FIG. 10, the server A1 does not transmit a communication packet to a server other than the server A2 and the server A3. As is apparent from the port number table T2b in FIG. 10, the server B1 does not transmit a communication packet to a server other than the server B2 and the server B3.

With regard to the example of FIGS. 10 and 11, the first to third conditions will be examined. First, the first condition will be examined. As described with reference to FIG. 10, specific server A1 and specific server B1 are determined to be same functional servers. Accordingly, it may be said that the first condition is satisfied.

Next, the second condition will be examined. Here, the server A2 and the server B2 are determined to be same functional servers. In addition, in two servers A2 and A3 to which the server A1 transmits a communication packet, only one server A3 is present as an undetermined server. In addition, in two servers B2 and B3 to which the server B1 transmits a communication packet, only one server B3 is present as an undetermined server. Accordingly, it can be said that the second condition is satisfied.

Next, the third condition is examined. As can be seen from the symbol P22a in FIG. 10, a standby port number that is used by software operating on one server A3 (to which an IP address “192.168.1.35” is set) is “9004”. In addition, as can be seen from the symbol P22b in FIG. 10, a standby port number that is used by software operating on one server B3 (to which an IP address “192.168.5.35” is set) is the same standby port number “9004”. Accordingly, it can be said that the third condition is satisfied.

As illustrated in FIG. 11, the first communication log comparison unit 42 determines one undetermined server A3 (refer to the symbol Ad3) in the first block A 20a and one undetermined server B3 (refer to the symbol Bd3) in the second block B 20b as same functional servers (refer to a symbol AR3).

Determination of Same Functional Server Based on Specific Port Number With Respect To Undetermined Server

The first communication log comparison unit 42 determines a same functional server based on a specific port number with respect to an undetermined server (step S5).

FIG. 12 is a diagram illustrating an example of a first table indication determination of a same functional server based on a specific port number with respect to an undetermined server, according to an embodiment.

IP addresses and port numbers which are stored in a port number table T2a in FIG. 12 are the same as the IP addresses and the port numbers which are stored in the port number table T2a in FIG. 10. In addition, IP addresses and port numbers which are stored in a port number table T2b in FIG. 12 are the same as the IP addresses and the port numbers which are stored in the port number table T2b in FIG. 10.

For the following description, in FIG. 12, a strike-through drawn as a dotted line is given to an IP address set to a transmission source server that is already determined to be a same functional server, or an IP address set to a transmission destination server that is already determined to be a same functional server. In addition, in communication that is executed by the determined transmission source server and the determined transmission destination server, a strike-through drawn as a dotted line is given to a port number (hereinafter, appropriately described as a determined port number) that is used by software operating on the determined transmission destination server.

Except for communication that is executed by the determined transmission source server and the determined transmission destination server, in a case where only one unit of communication (hereinafter, described as communication X) using an arbitrary specific port number is present in the first block A 20a and only one unit of communication using the arbitrary specific port number is present in the second block B 20b (hereinafter, described as a third case), the first communication log comparison unit 42 performs the following determination.

A communication log of the communication X in the first block A 20a is a first exclusion communication log obtained by excluding a first communication log, which includes IP addresses that are respectively set to two servers determined as same functional servers in the first block A 20a as a transmission source IP address and a transmission destination IP address, from a plurality of first communication logs.

A communication log of the communication X in the second block B 20b is a second exclusion communication log obtained by excluding a second communication log, which includes IP addresses that are respectively set to two servers determined as same functional servers in the second block B 20b as a transmission source IP address and a transmission destination IP address, from a plurality of second communication logs.

The first communication log comparison unit 42 extracts the first and second exclusion communication logs.

Here, a standby port number log, which includes an IP address set to an undetermined transmission source server and an IP address set to an undetermined transmission destination server, is described as an entirely undetermined standby port number log. In an example of the port number table T2a in FIG. 12, the entirely undetermined standby port number log includes standby port number logs indicated by symbols P23a to P25a. In an example of the port number table T2b in FIG. 12, the entirely undetermined standby port number log includes standby port number logs indicated by symbols P23b to P25b.

In other words, the third case is a case where only one standby port number is stored in the standby port number column of the port number table T2a in FIG. 10 and the standby port number column of the port number table T2b in FIG. 10 with the entirely undetermined standby port number logs in the port number table T2a in FIG. 12 and the port number table T2b in FIG. 12 made as a target.

Only one port number “9004” surrounded by a dotted-line circle in FIG. 12 is stored in a standby port number column as a same standby port number with the entirely undetermined standby port number logs in the port number table T2a in FIG. 12 and the port number table T2b in FIG. 12 made as a target.

In the third case, the first communication log comparison unit 42 determines the following two servers as same functional servers. In other words, in a case where it is determined that one matching transmission destination port number is present among transmission destination port numbers (standby port numbers) of one or more first exclusion communication logs and transmission destination port numbers of one or more second exclusion communication logs (third case), the first communication log comparison unit 42 performs the following determination process.

The first communication log comparison unit 42 determines a server to which a transmission source IP address of the first communication log including the matching transmission destination port number is set, and a server to which a transmission source IP address of the second communication log including the matching transmission destination port number is set as same functional servers. In addition, the first communication log comparison unit 42 determines a server to which a transmission destination IP address of the first communication log including the matching transmission destination port number is set, and a server to which a transmission destination IP address of the second communication log including the matching transmission destination port number is set as same functional servers.

For example, the first communication log comparison unit 42 determines the following two servers as same functional servers.

A first server is a server to which a transmission source IP address of a standby port number log including the same standby port number in the port number table T2a is set. A second server is a server to which a transmission source IP address of a standby port number log including the same standby port number in the port number table T2b is set.

In the case of the above-described example, the first communication log comparison unit 42 determines a server to which a transmission source IP address “12.3.0.142” of the standby port number log including a port number “9004” in the port number table T2a is set, and a server to which a transmission source IP address “12.5.0.142” of the standby port number log including a port number “9004” in the port number table T2b is set as same functional servers (refer to a symbol AR4).

In addition, in the third case, the first communication log comparison unit 42 determines the following two servers as same functional servers. A first server is a server to which a transmission destination IP address of the standby port number log including the same standby port number in the port number table T2a is set. A second server is a server to which a transmission destination IP address of the standby port number log including the same standby port number in the port number table T2b is set.

In a case of the above-described example, the first communication log comparison unit 42 determines a server to which a transmission destination IP address “12.0.3.7” of the standby port number log including the port number “9004” in the port number table T2a is set, and a server to which a transmission destination IP address “12.2.3.7” of the standby port number log including the port number “9004” in the port number table T2b is set as same functional servers (refer to a symbol AR5).

FIG. 13 is a diagram illustrating an example of a second table indicating determination of a same functional server based on a specific port number with respect to an undetermined server, according to an embodiment.

IP address and port numbers which are stored in a port number table T2a in FIG. 13 are the same as the IP addresses and the port numbers which are stored in the port number table T2a in FIG. 10. In addition, IP addresses and port numbers which are stored in a port number table T2b in FIG. 13 are the same as the IP addresses and the port numbers which are stored in the port number table T2b in FIG. 10.

For the following description, in FIG. 13, a strike-through drawn as a dotted line is given to an IP address set to a transmission source server that is already determined as a same functional server, or an IP address set to a transmission destination server that is already determined as a same functional server. In addition, a strike-through drawn as a dotted line is given to a determined port number.

In a fourth case, the first communication log comparison unit 42 performs the following determination. Except for communication that is executed by the determined transmission source server and an undetermined transmission destination server or communication that is executed by an undetermined transmission source server and the determined transmission destination server, the fourth case is a case where only one unit of communication (hereinafter, described as communication Y) using an arbitrary specific port number is present in the first block A 20a and only one unit of communication using the arbitrary specific port number is present in the second block B 20b.

A communication log of the communication Y in the first block A 20a is a first exclusion communication log obtained by excluding a first communication log, which includes an IP address set to a server determined as a same functional server in the first block A 20a as a transmission source IP address (or a transmission destination IP address), from a plurality of first communication logs.

A communication log of the communication Y in the second block B 20b is a second exclusion communication log obtained by excluding a second communication log, which includes an IP address set to a server determined as a same functional server in the second block B 20b as a transmission source IP address (or a transmission destination IP address), from a plurality of second communication logs.

The first communication log comparison unit 42 extracts the first and second exclusion communication logs.

Here, a standby port number log, which includes an IP address set to an undetermined transmission source server and an IP address set to a determined transmission destination server, is described as a partially undetermined standby port number log. Similarly, a standby port number log, which includes an IP address set to a determined transmission source server and an IP address set to an undetermined transmission destination server, is described as a partially undetermined standby port number log. In an example of the port number table T2a in FIG. 13, the partially undetermined standby port number log is a standby port number log indicated by a symbol P26a. In an example of the port number table T2b in FIG. 13, the partially undetermined standby port number log is a standby port number log indicated by a symbol P26b.

In other words, the fourth case is a case where only one same standby port number is stored in the standby port number column of the port number table T2a in FIG. 10 and the standby port number column of the port number table T2b in FIG. 10 with the partially undetermined standby port number logs in the port number table T2a in FIG. 13 and the port number table T2b in FIG. 13 made as a target.

Only one port number “25” surrounded by a dotted-line circle in FIG. 13 is stored in a standby port number column of the port number table T2a in FIG. 13 and a standby port number column of the port number table T2b in FIG. 13 as a same standby port number with the partially undetermined standby port number logs in the port number table T2a in FIG. 13 and the port number table T2b in FIG. 13 made as a target.

In the fourth case, the first communication log comparison unit 42 determines the following two servers as same functional servers. In other words, in a case where it is determined that one matching transmission destination port number is present among transmission destination port numbers of one or more first exclusion communication logs and transmission destination port numbers of one or more second exclusion communication logs (fourth case), the first communication log comparison unit 42 performs the following determination process.

The first communication log comparison unit 42 determines a server to which a transmission destination IP address (or a transmission source IP address) of the first communication log including the matching transmission destination port number is set, and a server to which a transmission destination IP address (or a transmission source IP address) of the second communication log including the matching transmission destination port number are set as same functional servers.

For example, the first communication log comparison unit 42 determines the following two servers as same functional servers.

A first server is an undetermined server of the standby port number log including the same standby port number in the port number table T2a. A second server is an undetermined server of the standby port number log including the same standby port number in the port number table T2b. In addition, the undetermined server is a server to which an IP address to which a strike-through is not applied in FIG. 13 is set.

In a case of the above-described example, the first communication log comparison unit 42 determines a server to which a transmission source IP address “192.168.1.26”, to which a strike-through is not given, of the standby port number log including a port number “25” in the port number table T2a is set, and a server to which a transmission source IP address “192.168.5.26”, to which a strike-through is not given, of the standby port number log including a port number “25” in the port number table T2b is set as same functional servers (refer to a symbol AR6).

The first communication log comparison unit 42 determines whether or not the same functional server is determined in step S4 and step S5 described above (step S6). In a case where the same functional server is determined by the first communication log comparison unit 42 (YES in step S6), the process returns again to step S4.

When the determination process in step S4 and step S5 is executed again after determining the same functional server, a same functional server, which is not determined in an immediately previous determination process, may be determined. Accordingly, the process returns again to step S4 to execute again the process of determining the same functional server.

On the other hand, when the first communication log comparison unit 42 does not determine the same functional server (NO in step S6), the process transitions to step S7.

The first communication log comparison unit 42 determines whether or not a same functional server analogy mode is “ON” (step S7). In a case where the same functional server analogy mode is “ON” (YES in step S7), the first communication log comparison unit 42 analogizes the same functional server (Step S8).

Analogy of Same Functional Server

A method of analogizing the same functional server in step S8 of FIG. 7 will be described with reference to FIGS. 14 to 17. In the following description, logs different from the standby port number logs illustrated in FIGS. 10, 12, and 13 are illustrated for a concise description of the method of analogizing the same functional server.

FIG. 14 is a diagram illustrating an example of a method of analogizing a same function server, according to an embodiment. In FIG. 14, communication executed in the first block A 20a and the second block B 20b is illustrated so as to illustrate the method of analogizing the same function server. In FIG. 14, a solid-line arrow schematically illustrates transmission of a communication packet.

In the first block A 20a, a server (hereinafter, described as a server A5), to which an IP address “X1.Y1.Z1.W1” (refer to a symbol Ad11 in FIG. 14) is set, transmits a communication packet to the following three servers.

A first server is a server (hereinafter, described as a server A6) to which an IP address “X12.Y12.Z12.W12” (refer to a symbol Ad12 in FIG. 14) is set. A second server is a server (hereinafter, described as a server A7) to which an IP address “X13.Y13.Z13.W13” (refer to a symbol Ad13 in FIG. 14) is set. A third server is a server (hereinafter, described as a server A8) to which an IP address “X14.Y14.Z14.W14” (refer to a symbol Ad14 in FIG. 14) is set. In addition, the three servers are servers included in the first block A 20a.

A server (hereinafter, described as a server B5) of the second block B 20b to which an IP address “X1′.Y1′.Z1′.W1′” (refer to a symbol Bd11 in FIG. 14) is set transmits a communication packet to the following three servers.

A first server is a server (hereinafter, described as a server B6) to which an IP address “X12′.Y12′.Z12′.W12′” (refer to a symbol Bd12 in FIG. 14) is set. A second server is a server (hereinafter, described as a server B7) to which an IP address “X13′.Y13′.Z13′.W13′” (refer to a symbol Bd13 in FIG. 14) is set. A third server is a server (hereinafter, described as a server B8) to which an IP address “X14′.Y14′.Z14′.W14′” (refer to a symbol Bd14 in FIG. 14) is set. In addition, the three servers are servers in 20b that an operation verification target. In addition, a symbol G in FIG. 14 will be described later.

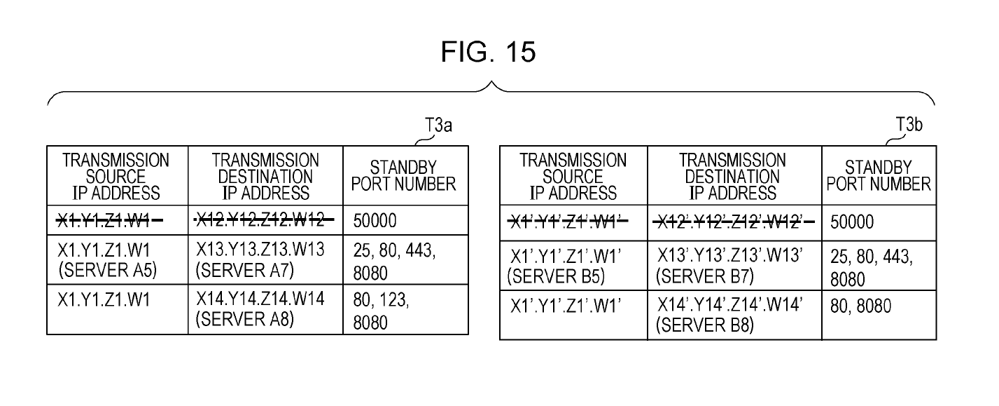

FIG. 15 is a diagram illustrating an example of a table storing standby port number logs, according to an embodiment. The standby port number logs of FIG. 15 are listed based on communication logs of the first block A 20a and the second block B 20b and include communication contents illustrated in FIG. 14.

A port number table T3a is a table that stores standby port number logs which include communication contents illustrated in FIG. 14 and which are listed based on communication logs of the first block A 20a. A port number table T3b is a table that stores standby port number logs which include communication contents illustrated in FIG. 14 and which are listed based on communication logs of the second block B 20b.

The first communication log comparison unit 42 executes a process of determining a same functional server (step S3 to step S6) with respect to a plurality of standby port number logs that are stored in the port number table T3a and the port number table T3b, respectively.

Here, only one unit of communication using a specific port number “50000” is present in the first block A 20a and only one unit of communication using the specific port number “50000” is present in the second block B 20b. Accordingly, the first communication log comparison unit 42 executes step S3 and determines the server A5 and the server B5 as a same functional server. In addition, the first communication log comparison unit 42 executes step S3 and determines the server A6 and the server B6 as a same functional server. In FIG. 15, a strike-through drawn as a dotted line is given to an IP address set to a server that is determined as a same functional server.

In addition, even when the processes in step S4 and S5 are executed with respect to the servers A7, A8, B7, and B8, these servers are not determined as same functional servers, and thus these servers are undetermined servers.

Hereinafter, a process of analogizing a same functional server will be described. Specifically, with reference to a plurality of first communication logs, the first communication log comparison unit 42 determines whether or not among a plurality of servers that are transmission destinations with which a server determined (searched for) as a same functional server in the first device group communicates, a plurality of first servers that are not determined as same functional servers are present.

In addition, with reference to a plurality of second communication logs, the first communication log comparison unit 42 determines whether or not among a plurality of servers that are transmission destinations with which a server determined as a same functional server in the second device group communicates, a plurality of second servers that are not determined as same functional servers are present.

In a case where the plurality of first servers and the plurality of second servers are present, the first communication log comparison unit 42 executes the following processes. That is, the first communication log comparison unit 42 also calculates a degree of similarity between transmission destination port numbers that are respectively set to the plurality of first servers that are not determined as same functional servers and transmission destination port numbers that are respectively set to the plurality of second servers that are not determined as same functional servers.

In addition, the first communication log comparison unit 42 determines a server to which a transmission destination IP address of a first communication log including a transmission destination port number having the highest degree of similarity is set, and a server to which a transmission destination IP address of a second communication log including a transmission destination port number having the highest degree of similarity is set as a same functional server.

For example, the first communication log comparison unit 42 determines an undetermined transmission destination server in communication with a determined transmission source server as a server that is a matching candidate. In an example of FIG. 14, the first communication log comparison unit 42 determines four servers surrounded by a broken line indicated by a symbol G, that is, the servers A7, A8, B7, and B8 as servers that are matching candidates.

Next, the first communication log comparison unit 42 calculates the degree of similarity (also, referred to as a matching degree) between standby port numbers in respective servers that are matching candidates in the first block A 20a and standby port numbers in respective servers that are matching candidates in the second block B 20b. In addition, the first communication log comparison unit 42 determines a server that is a matching candidate in the first block A 20a and a server that is a matching candidate in the second block B 20b, to which a standby port number having the highest degree of similarity is set, as a same functional server.

In the example of FIGS. 14 and 15, first, the first communication log comparison unit 42 calculates the degree of similarity between standby port numbers in the server A7 and standby port numbers in the servers B7 and B8. In addition, the first communication log comparison unit 42 calculates the degree of similarity between standby port numbers in the server A8 and standby port numbers in the servers B7 and B8.

The first communication log comparison unit 42 uses, for example, the following Expression 1 during calculation of the degree of similarity.

Degree of similarity

$$S = \frac{1}{2} ( \frac{n}{{n}_{a}} + \frac{n}{{n}_{b}} ) \qquad ( Expression 1 )$$

Expression 1 will be described. For example, the degree of similarity between standby port numbers of a server a and standby port numbers of a server b is assumed. In this case, n represents the number of matching standby port numbers in the standby port numbers of the server a and the standby port numbers of the server b. nₐ represents the number of the standby port numbers of the server a. n_{b} represents the number of the standby port numbers of the server b.

A case of calculating the degree of similarity (hereinafter, described as degree of similarity X) between the standby port numbers in the server A7 and the standby port numbers in the server B7 by using Expression 1 is exemplified. In the standby port numbers of the server A7 and the standby port numbers of the server B7, there are four matching standby port numbers of “25”, “80”, “443”, and “8080”. Accordingly, during calculation of the degree of similarity X, n in Expression 1 is 4.

The number of the standby port numbers in the server A7 is 4, and thus nₐ in Expression 1 is 4. The number of the standby port numbers in the server B7 is 4, and thus n_{b} in Expression 1 is 4. Accordingly, during calculation of the degree of similarity X, n, nₐ, and n_{b} of Expression 1 are respectively substituted with 4, 4, and 4, the degree of similarity X becomes 1.

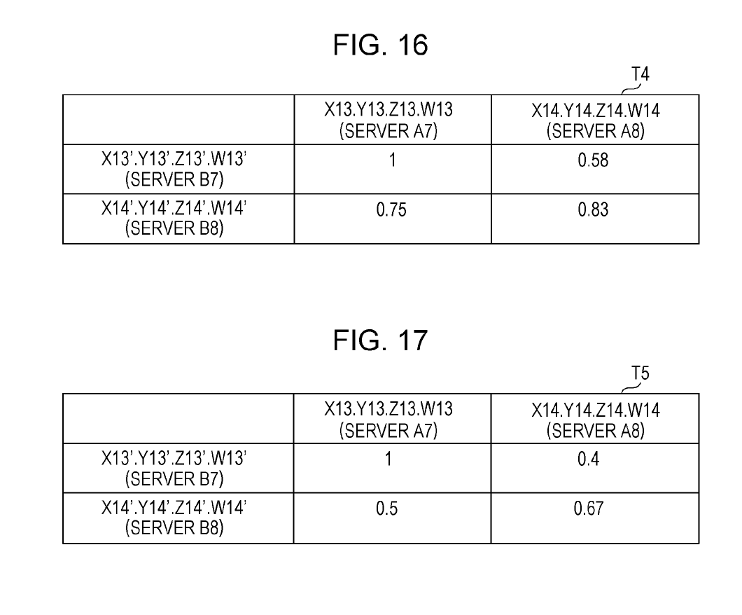

FIG. 16 is a diagram illustrating an example of a first table indicating calculation results of a degree of similarity, according to an embodiment. FIG. 16 shows calculation results of a degree of similarity between respective standby port numbers in the server A7 and A8 and respective standby port numbers in the servers B7 and B8.

In FIG. 16, the degree of similarity between the standby port numbers of the servers (servers B7 and B8) illustrated in respective rows and the standby port numbers of the servers (servers A7 and A8) illustrated in respective columns is illustrated in cells in which the respective rows and the respective columns intersect each other.

The first communication log comparison unit 42 stores a degree-of-similarity table T4 of FIG. 16 in the storage device 403. Through the above-described process of calculating the degree of similarity, the first communication log comparison unit 42 calculates the degree of similarity between the standby port numbers of the server A7 and the standby port numbers of the server B8 as “0.75”. The first communication log comparison unit 42 calculates the degree of similarity between the standby port numbers of the server A8 and the standby port numbers of the server B7 as “0.58”. The first communication log comparison unit 42 calculates the degree of similarity between the standby port numbers of the server A8 and the standby port numbers of the server B8 as “0.83”. In addition, the first communication log comparison unit 42 stores the calculation results in cells, which correspond to the respective servers, of the degree-of-similarity table T4 of FIG. 16.

The first communication log comparison unit 42 determines two servers, which relate to the highest degree of similarity among the degrees of similarity that are calculated, as a same functional server. In the example of FIGS. 14 to 16, the two servers, which relate to the highest degree of similarity (“1”) are the servers A7 and B7 in the calculation of the degree of similarity X. Accordingly, the first communication log comparison unit 42 determines the servers A7 and B7 to be same functional servers.

In addition, during calculation of the degree of similarity, a Jaccard coefficient, which is defined in Expression 2 and represents a degree of similarity between groups, may be used.

Degree of similarity

$$S = sim ( {C}_{i} , {C}_{j} ) = \frac{\vert {C}_{i} ⋂ {C}_{j} \vert}{\vert {C}_{i} ⋃ {C}_{j} \vert} \qquad ( Expression 2 )$$

In Expression 2, Cᵢ represents a set of standby port numbers in a matching candidate server; in the first block A 20a. In addition, in Expression 2, Cⱼ represents a set of standby port numbers in a matching candidate server) in the second block B 20b.

In the example of FIGS. 14 and 15, Cᵢ represents {25, 80, 443, 8080} which is a set of the standby port numbers in the server A7. C₂ represents {25, 80, 443, 8080} which is a set of the standby port numbers in the server B7. C₃ represents {80, 123, 8080} which is a set of the standby port numbers in the server A8. C₄ represents {80, 8080} which is a set of the standby port numbers in the server B8. The first communication log comparison unit 42 performs the following process of calculating the degree of similarity by using Expression 2.

That is, the first communication log comparison unit 42 calculates the degree of similarity between the standby port numbers (set C₁) of the server A7 and the standby port numbers (set C₂) of the server B7 as “1.00” (4/4).

In addition, the first communication log comparison unit 42 calculates the degree of similarity between the standby port numbers (set C₁) of the server A7 and the standby port numbers (set C₃) of the server B8 as “0.50” (2/4).

In addition, the first communication log comparison unit 42 calculates the degree of similarity between the standby port number (set C₃) of the server A8 and the standby port numbers (set C₂) of the server B7 as “0.40” (2/5).

In addition, the first communication log comparison unit 42 calculates the degree of similarity between the standby port number (set C₃) of the server A8 and the standby port numbers (set C₄) of the server B8 as “0.67” (2/3).

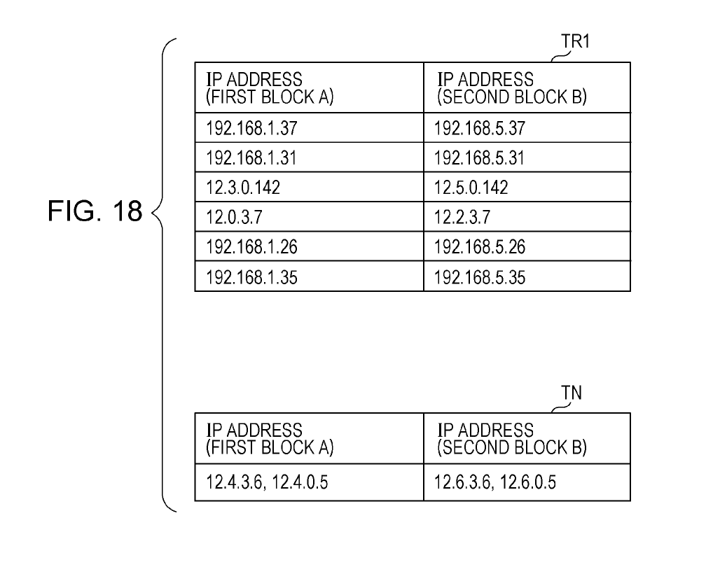

FIG. 17 is diagram illustrating an example of a second table indicating calculation results of a degree of similarity, according to an embodiment. FIG. 17 shows calculation results of a degree of similarity between respective standby port numbers in the server A7 and A8 and respective standby port numbers in the servers B7 and B8.

The first communication log comparison unit 42 stores the above-described calculation results in cells, which correspond to respective servers, of a degree-of-similarity table T5 of FIG. 17. The first communication log comparison unit 42 determines two servers, which relate to the highest degree of similarity among the degrees of similarity that are calculated, as a same functional server. In the example of FIGS. 14, 15, and 17, the two servers, which relate to the highest degree of similarity (“1.00”) are the servers A7 and B7. Accordingly, the first communication log comparison unit 42 determines the servers A7 and B7 as same functional servers.

Through the analogy process, it is possible to determine servers, which are not determined as same functional servers even in the processes in step S3 to S5, as same functional servers. Accordingly, it is possible to create an IP address-corresponding table including more IP addresses as information used during automatic detection of a setting error of communication-related information.

Process of Recording IP Address of Same Functional Server

The correlation creation unit 43 stores an IP address set to the same functional server determined by the process of determining a same functional server which is illustrated in the flowchart of FIG. 7, or an IP address set to a server (undetermined server) that is not determined as a same functional server in the storage device 403, for example, in a table type.

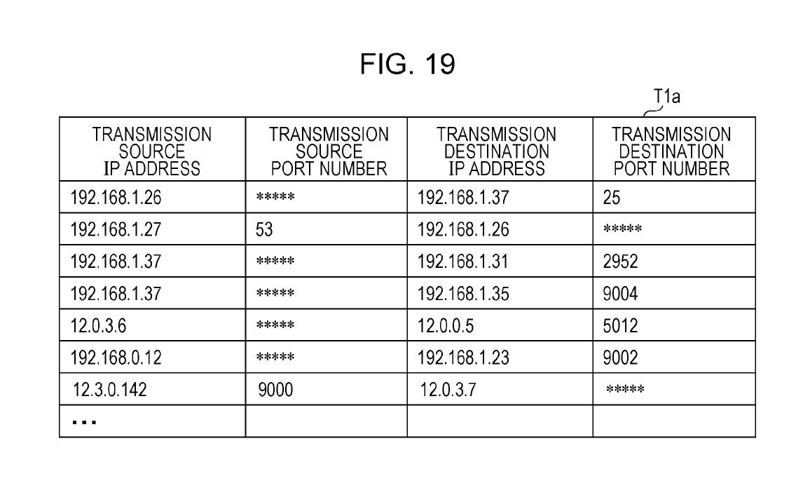

FIG. 18 is a diagram illustrating an example of tables that store information on determined same functional servers and undetermined servers, according to an embodiment. A server-corresponding table TR1 is an example of a table in which a determined same functional server is stored. An undetermined server table TN is an example of a table in which an undetermined server is stored.

The server-corresponding table TR1 includes an IP address column (first block A), and an IP address column (second block B). The IP address column (first block A) stores an IP address set to a server of the first block A 20a. The IP address column (second block B) stores an IP address set to a server of the second block B 20b.

In the server-corresponding table TR1 in FIG. 18, respective servers to which IP addresses stored in the same row are set are same functional servers. Here, a server to which an IP address “192.168.1.37” stored in the IP address column (first block A) is set is described as a server A10. The server A10, and a server to which an IP address “192.168.5.37” stored in the IP address column (second block B) in the same row as the IP address “192.168.1.37” is set are same functional servers.

The undetermined server table TN in FIG. 18 stores includes an IP address column (first block A), and an IP address column (second block B). The IP address column (first block A) stores an IP address set to an undetermined server of the first block A 20a. The IP address column (first block A) stores an IP address set to an undetermined server of the second block B 20b.

In addition, the notification unit 47 may display the server-corresponding table TR1 in FIG. 18 on the display device 406a in combination with a character string “determined server is as follows”. In addition, the notification unit 47 may display the undetermined server table TN in FIG. 18 on the display device 406a in combination with a character string “undetermined server is as follow”.

According to the process of determining a same functional server as described above, it is possible to automatically create a server-corresponding table which is information used when automatically detecting a setting error of communication-related information. As a result, the manager is not requested to manually create the server-corresponding table, and thus it is possible to reduce man-hours and the time for operation verification.

Detection of Setting Error

Hereinafter, a process of detecting a setting error will be described. FIG. 19 is a diagram illustrating an example of a second table indicating a communication log database, according to an embodiment. FIG. 19 shows an example of communication log database DB1 in FIG. 5. A communication log table Tia is an example of a table that stores a communication log that is acquired by the management device 4 from the first block A 20a. A state in which the communication log database DB1 in FIG. 5 stores the communication log table T1a is indicated by the symbol To in FIG. 5.

The communication log table Tla includes a transmission source IP address column, a transmission source port number column, a transmission destination IP address column, and a transmission destination port number column. In the communication log table T1a, one communication log is stored for each row. In addition, contents of each column will be described later.

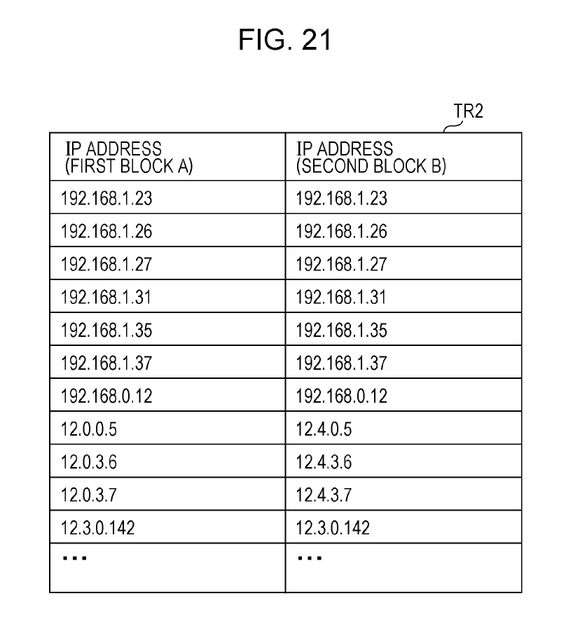

FIG. 20 is a diagram illustrating an example of a third table indicating a communication log database, according to an embodiment. FIG. 20 shows an example of the communication log database DB1 in FIG. 5. A communication log table Tlb is an example of a table that stores a communication log that is acquired by the management device 4 from the second block B 20b. A state in which the communication log database DB1 in FIG. 5 stores the communication log table T1b is indicated by the symbol Ts in FIG. 5.

The communication log table T1b includes a transmission source IP address column, a transmission source port number column, a transmission destination IP address column, and a transmission destination port number column, and a state column. In the communication log table T1b, one communication log is stored for each row. In addition, contents of each column will be described later.

Server-Corresponding Database

FIG. 21 is a diagram illustrating an example of a table indicating a server-corresponding database, according to an embodiment. FIG. 21 shows an example of the server-corresponding database DB2 in FIG. 5. A state in which the server-corresponding database DB2 stores the server-corresponding table TR2 in FIG. 5 is indicated by the symbol TR in FIG. 5. The server-corresponding table TR2 also has the same table configuration as the server-corresponding table TR1 illustrated with reference to FIG. 18. In addition, an IP address stored in a cell of the server-corresponding table TR2 and an IP address stored in a cell of the server-corresponding table TR1 are different from each other for convenience of description.

The server-corresponding table TR2 includes an IP address column (first block A) and an IP address column (second block B). The IP address column (first block A) stores an IP address set to a server of the first block A 20a. The IP address column (second block B) stores an IP address set to a server of the second block B 20b.

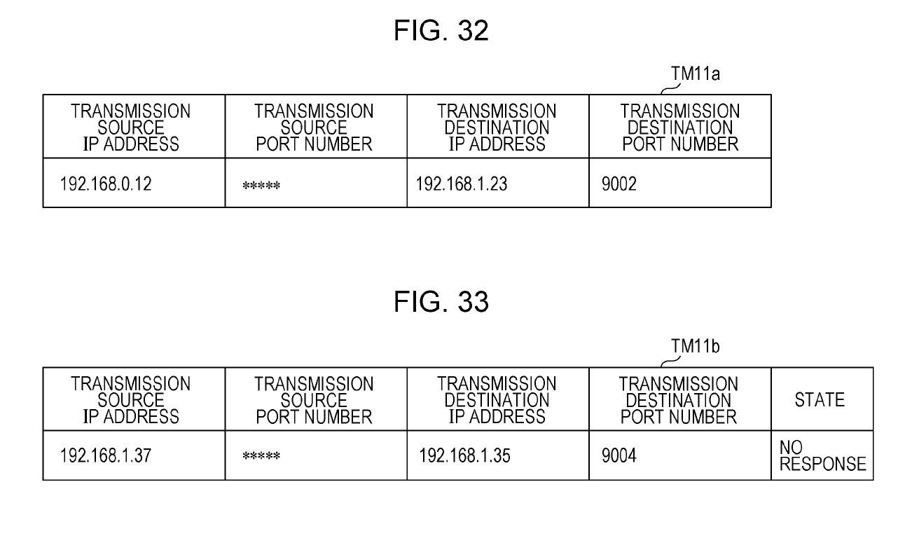

The server-corresponding table TR2 is an example of corresponding information in which a device of the first device group in which the operation verification is completed and a device of the second device group that is an operation verification target are correlated with each other. The storage device 403 in FIG. 5 stores the corresponding information. In addition, as illustrated in FIG. 31, an IP address “12.0.3.7” is not stored in the IP address (second block B) column of the server-corresponding table TR2.

The first device group is, for example, the block management server group 21 of the first block A 20a in FIG. 2. The device of the first device group is, for example, the image management server 212, and the like. The second device group is, for example, the block management server group 23 of the second block B 20b in FIG. 2. The device of the second device group is, for example, a server of the second block B 20b, and examples of the server include the image management server 232 and the like.

In FIG. 21, respective servers, to which IP addresses stored in the same row are set, are same functional servers. Here, a server to which an IP address “192.168.1.23” stored in the IP address column (first block A) is set is described as a server A. The server A, and a server (hereinafter, referred to as a server B) to which an IP address “192.168.1.23” stored in the IP address column (second block B) in the same row as the IP address “192.168.1.23” is set are same functional servers. For example, in a case where the server A is a DNS server, the server B is also a DNS server.

That is, the server-corresponding table TR2 includes IP addresses set to first devices of the first device group in which the operation verification is completed, and IP addresses set to second devices of the second device group which have the same functions as the first devices and which are operation verification targets.

Process of Acquiring Communication Log and Process of Merging Communication Log

Before the operation verification, the communication log acquisition unit 41 of the management device 4 in FIG. 6 acquires a communication log of the first device group in which the operation verification is completed as described in step S1 in FIG. 7. The communication log acquisition unit 41 outputs the communication log that is acquired, to the first communication log comparison unit 42 and the communication log trimming unit 44. In addition, the communication log acquisition unit 41 acquires a communication log of the second device group that is an operation verification target during the operation verification. The communication log acquisition unit 41 outputs the communication log that is acquired, to the first communication log comparison unit 42 and the communication log trimming unit 44.

The first communication log comparison unit 42 executes a process of determining a same functional server based on the communication log for the first device group in which the operation verification is completed, and the communication log of the second device group that is an operation verification target. In addition, the correlation creation unit 43 creates a server-corresponding table in which respective IP address set to same functional servers are correlated with each other, and stores the server-corresponding table in the server-corresponding database DB2. The server-corresponding table is, for example, the server-corresponding table TR2 in FIG. 21.

In addition, the communication log trimming unit 44 appropriately trims (also, referred to as merging) the input communication log of the first device group in which the operation verification is completed. Similarly, the communication log trimming unit 44 appropriately merges the input communication log of the first device group in which the operation verification is completed.

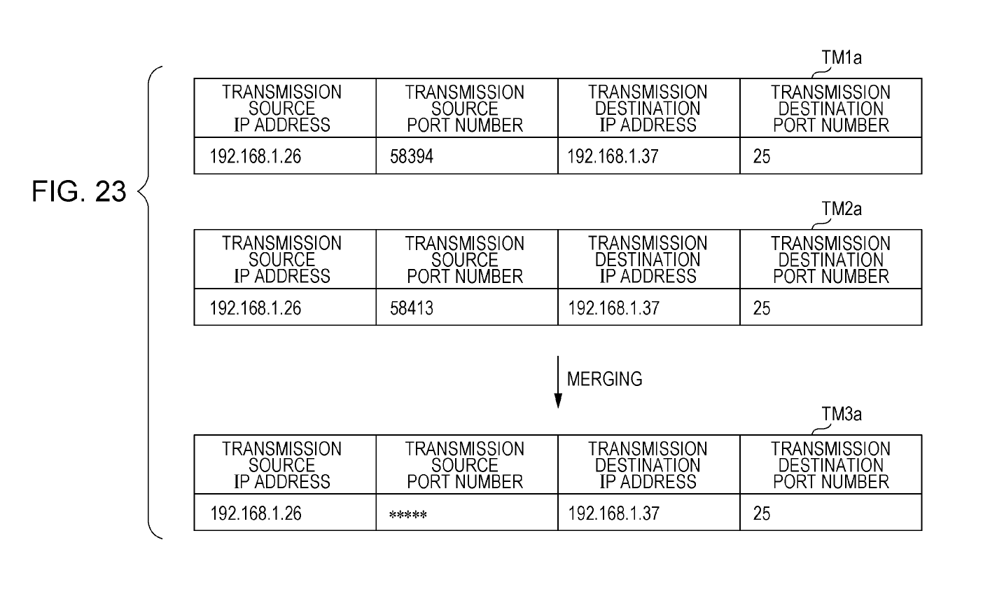

FIG. 22 is a diagram illustrating an example of an operational flowchart for a process of acquiring a communication log and merging a communication log, according to an embodiment. The flows of the processes executed by the communication log acquisition unit 41 and the communication log trimming unit 44 in FIG. 6 will be described with reference to FIG. 22.

Step S11: The communication log acquisition unit 41 acquires a communication log of the first device group in which the operation verification is completed, and a communication log of the second device group that is an operation verification target. In addition, in step S11, the same process as step S1 in FIG. 7 is executed, and a description thereof will not be repeated. Here, the first communication log comparison unit 42 executes the process of determining a same functional server with reference to the acquired communication log of the first device group in which the operation verification is completed and the communication log of the second device group that is an operation verification target. The correlation creation unit 43 creates a server-corresponding table with reference to an IP address set to a determined same functional server, and stores the server-corresponding table in the server-corresponding database DB2. The above-described server-corresponding table is set, for example, as the server-corresponding table TR2 in FIG. 21.

Step S12: The communication log trimming unit 44 determines whether or not a communication log in which matching is established with both of a transmission source IP address and a transmission destination IP address of the acquired communication log is stored in the communication log database DB1

Specifically, in a case where the communication log acquisition unit 41 acquires a communication log of the first block A 20a in which the operation verification is completed, the communication log trimming unit 44 determines whether or not a communication log in which matching is established with both a transmission source IP address and a transmission destination IP address of the acquired communication log is stored in the communication log table T1a. On the other hand, in a case where the communication log acquisition unit 41 acquires a communication log of the second block B 20b that is an operation verification target, the communication log trimming unit 44 determines whether or not a communication log in which matching is established with both a transmission source IP address and a transmission destination IP address of the acquired communication log is stored in the communication log table T1b.

In a case where it is determined by the communication log trimming unit 44 that a communication log in which matching is established with both the transmission source IP address and the transmission destination IP address of the acquired communication log is not stored in the communication log database DB1 (NO in step S12), the process transitions to step S13.

Step S13: The communication log trimming unit 44 stores a communication log that is acquired by the communication log acquisition unit 41 in the communication log database DB1. Specifically, in a case where the communication log acquisition unit 41 acquires a communication log of the first block A 20a in which the operation verification is completed, the communication log trimming unit 44 stores a transmission source IP address, a transmission destination IP address, a transmission source port number, and a transmission destination port number of the communication log that is acquired, in the communication log table T1a.

On the other hand, in step S12, in a case where it is determined by the communication log trimming unit 44 that a communication log in which matching is established with both the transmission source IP address and the transmission destination IP address of the communication log acquired by the communication log acquisition unit 41 is stored in the communication log database DB1 (YES in step S12), the process transitions to step S14.

Step S14: The communication log trimming unit 44 determines whether or not a communication log in which matching is established with any one of a transmission source port number and a transmission destination port number of the communication log acquired by the communication log acquisition unit 41 is stored in the communication log database DB1. Specifically, in a case where the communication log acquisition unit 41 acquires a communication log of the first block A 20a, the communication log trimming unit 44 determines whether or not a communication log in which matching is established with any one of a transmission source port number and a transmission destination port number of the acquired communication log is stored in the communication log table T1a in FIG. 19. On the other hand, in a case where the communication log acquisition unit 41 acquires a communication log of the second block B 20b, the communication log trimming unit 44 determines whether or not a communication log in which matching is established with any one of a transmission source port number and a transmission destination port number of the acquired communication log is stored in the communication log table T1b in FIG. 20.

In step S14, in a case where it is determined that a communication log in which matching is established with any one of the transmission source port number and the transmission destination port number of the communication log acquired by the communication log acquisition unit 41 is stored in the communication log database DB1 (YES in step S14), the process transitions to step S15. Hereinafter, among communication logs that are stored in the communication log database DB1, a communication log in which matching is established with both the transmission source IP address and the transmission destination IP address of the communication log acquired by the communication log acquisition unit 41, and with any one of the transmission source port number and the transmission destination port number of the communication log is appropriately described as a merging source communication log.

Step S15: The communication log trimming unit 44 merges the merging source communication log that is stored in the communication log database DB1, and the communication log acquired by the communication log acquisition unit 41 with each other. In addition, merging of two communication logs in step S15 will be described in detail with reference to FIG. 31.

In step S14, in a case where it is determined that a communication log in which matching is established with any one of the transmission source port number and the transmission destination port number of the communication log acquired by the communication log acquisition unit 41 is not stored in the communication log database DB1 (NO in step S14), the process transitions to step S13.

In a case where a plurality of communication logs are acquired in step S11, as illustrated in loops LP1 and LP2, the communication log trimming unit 44 executes the processes in step S11 to step S15 with respect to respective logs acquired by the communication log acquisition unit 41.

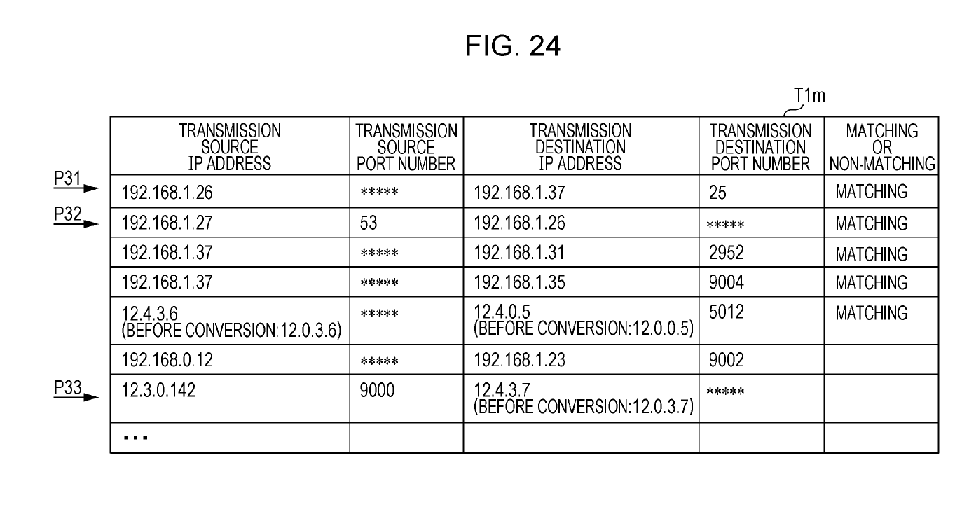

FIG. 23 is a diagram illustrating an example of a process of acquiring and merging a communication log, according to an embodiment. In FIG. 23, a communication log TM1a is a communication log of the first block A 20a which is acquired by the communication log acquisition unit 41. A communication log TM2a is a communication log of the first block A 20a which is acquired by the communication log acquisition unit 41 after acquisition of the communication log TM1a. In addition, the communication log TM1a and the communication log TM2a are illustrated in a table type. In addition, in FIG. 23, a merged communication log TM3a is a view illustrating a state in which the communication log trimming unit 44 merges the communication logs TM1a and TM2a, in a table type.

A process flow of FIG. 22 will be described in detail with reference to FIGS. 19, 22, and 23. For example, the communication log acquisition unit 41 acquires first and second communication logs from any server (for example, the image management server 212) in the block management server group 21 of the first block A 20a (step S11).

The first communication log is, for example, the communication log TM1a in FIG. 23. The communication log TM1a is a communication log including a transmission source IP address “192.168.1.26”, a transmission source port number “58394”, a transmission destination IP address “192.168.1.37”, and a transmission destination port number “25”. The second communication log is, for example, the communication log TM2a in FIG. 23. The communication log TM2a is a communication log including a transmission source IP address “192.168.1.26”, a transmission source port number “58413”, a transmission destination IP address “192.168.1.37”, and a transmission destination port number “25”.

Here, in a case where a communication log in which matching is established with both the transmission source IP address “192.168.1.26” and the transmission destination IP address “192.168.1.37” of the communication log TM1a is not stored in the communication log table T1a of the communication log database DB1 in FIG. 19 (NO in step S12), the communication log trimming unit 44 executes the following processes. Specifically, as illustrated in the communication log TM1a in FIG. 23, the communication log trimming unit 44 stores the communication log TM1a in the communication log table T1a of the communication log database DB1 (step S13).

Subsequently, the process returns to the loop LP1 from the loop LP2 and transitions to step S12. In step S12, when it is determined by the communication log trimming unit 44 that a communication log in which matching is established with both a transmission source IP address and a transmission destination IP address of the communication log TM2a is stored in the communication log database DB1 (YES in step S12), the process transitions to step S14. In this case, the communication log TM1a becomes the merging source communication log.

The reason of the determination as YES in step S12 is that the communication logs TM1a and TM2a match each other in both the transmission source IP address (“192.168.1.26”) and the transmission destination IP address (“192.168.1.37”), and the communication log TM1a is stored in the communication log database DB1.

In step S14, when it is determined by the communication log trimming unit 44 that a communication log in which matching is established with any one of the transmission source port number and the transmission destination port number of the communication log TM2a is stored in the communication log database DB1 (YES in step S14), the process transitions to step S15. The reason of the determination as YES in step S14 is that transmission destination port numbers (“25”) of the communication logs TM1a and TM2a match each other.

The first communication log trimming unit 44 merges the communication log TM1a and the communication log TM2a which are stored in the communication log database DB1 (step S15). In step S15, the communication log trimming unit 44 merges the transmission source port number “58394” of the communication log TM1a and the transmission source port number “58413” of the communication log TM2a. A merged state is illustrated in the merged communication log TM3a in FIG. 23. Here, in the merged communication log TM3a, “*****” in a transmission source port number column schematically illustrates a state in which port numbers are merged. In addition, the communication log trimming unit 44 stores the merged state in the communication log database DB1 as illustrated in the uppermost end of the communication log table T1a in FIG. 19.

The merging in step S15 represents that both communication logs satisfying conditions described in step S12 and step S14 in FIG. 22 (YES in step S12 and step S14) are collectively integrated as one communication log.

Specifically, in the merging in step S15, in a case where a transmission source port number of a merging source communication log and a transmission source port number of a communication log that is acquired match each other, the transmission source port number of the merging source communication log is converted into an arbitrary character string (for example, “*****”). In addition, in the merging, in a case where a transmission destination port number of the merging source communication log and a transmission destination port number of the communication log that is acquired match each other, the transmission destination port number of the merging source communication log is converted into an arbitrary character string. An arbitrary numerical value (for example, 0xFFFFF (hexadecimal) is also possible instead of the character string.

As described with reference to FIGS. 22 and 23, in a case where the following conditions are satisfied, the communication log trimming unit 44 integrates two first communication logs (communication logs of the first block A 20a) and stores the integrated communication logs in the storage device 24 as one first communication log. The above-described conditions represent a case where the transmission source IP addresses and the transmission destination IP addresses which are included in the two first communication logs match each other, respectively, and the transmission source port numbers or the transmission destination port numbers which are included in the two first communication logs match each other.

In addition, as described with reference to FIGS. 22 and 23, in a case where the following conditions are satisfied, the communication log trimming unit 44 integrates two second communication logs (communication logs of second block B 20b) and stores the integrated communication logs in the storage device 24 as one second communication log. The above-described conditions represent a case where the transmission source IP addresses and the transmission destination IP addresses which are included in the two second communication logs match each other, respectively, and the transmission source port numbers or the transmission destination port numbers which are included in the two second communication logs match each other.

Hereinafter, the reason why the communication logs are merged will be described. The reason is to reduce an amount of communication logs that are stored in a database. For example, it is assumed that first software and second software which are executed by an arbitrary server make a request for data processing (also, referred to as a service) to third software executed by a different server. Here, the third software is software that executes a process of transmitting electronic mail by SMTP, and performs communication with the first software and the second software.

The first software makes a request for electronic mail transmission to the third software, for example, by using a transmission source port number “58394” and a transmission destination port number “25”. In addition, the second software makes a request for electronic mail transmission to the third software, for example, by using a transmission source port number “58413” and a transmission destination port number “25”.

During a communication process, service request destination software is in a standby state for service request by using a specific port number (in the above-described example, “25”), and thus a transmission destination port number is fixed. On the other hand, service request source software typically includes a plurality of pieces of software, and the plurality of pieces of software use port numbers different from each other. In addition, even when the same software makes a request for a service, whenever a request for a service is made, a different port number may be used in some cases. In other words, the transmission source port number is frequently changed.

In addition, the service request destination software may transmit a response message to a plurality of pieces of different service request source software, respectively. The response message is also recorded as a communication log. In this manner, in a case where the service request destination software transmits the response message to the plurality of pieces of different service request source software, a transmission source port number is the same, but a transmission destination port number is different in each case.

As described above, a communication process, in which a nonspecific port number is used as a transmission source port number and a specific port number is used as a transmission destination port number, occurs. In addition, a communication process, in which a specific port number is used as a transmission source port number and a nonspecific port number is used as a transmission destination port number, may occur in some cases. Accordingly, during merging of the communication log, a communication log is stored in the communication log database DB1 in a state in which the nonspecific port number is merged. Due to the merging, it is possible to reduce the data amount of the communication log that is stored in the communication log database DB1. In addition, during the following comparison of communication logs, a comparison process may be quickly executed.

Subsequently, the second communication log comparison unit 45 executes comparison of a communication log, and the error detection unit 46 executes detection of a communication-related setting error.

Conversion of IP Address of Communication Log

Before detection of the communication-related setting error, the second communication log comparison unit 45 executes conversion of an IP address of a communication log based on the server-corresponding table TR2 in FIG. 21 so as to execute the detection of the setting error with high accuracy.

As described above, the server-corresponding table TR2 includes an IP address set to a device of the first device group in which the operation verification is completed, and an IP address set to a device of the second device group which is an operation verification target, the device having the same function as the device of the first device group.

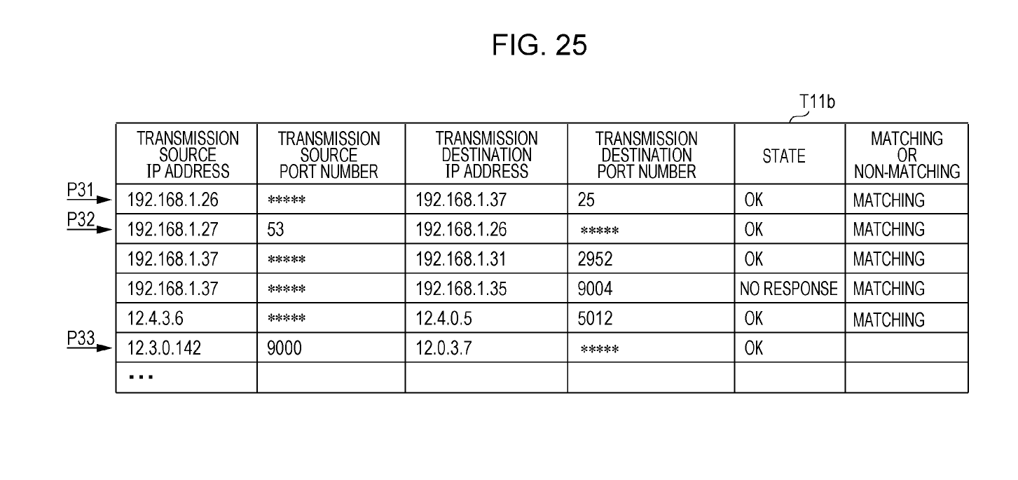

The second communication log comparison unit 45 converts a transmission source IP address and a transmission destination IP address of a first communication log to an IP address set to a device of the second device group that is an operation verification target based on the server-corresponding table TR2, where the device corresponds to the transmission source IP address and the transmission destination IP address. The conversion process will be described in detail with reference to FIG. 24. In addition, the second communication log comparison unit 45 may convert a transmission source IP address and a transmission destination IP address of a second communication log to an IP address set to a device of the first device group in which the operation verification is completed based on the server-corresponding table TR2, where the device corresponds to the transmission source IP address and the transmission destination IP address.

FIG. 24 is a diagram illustrating an example of a table indicating a process of converting a communication log, according to an embodiment. The process of converting a communication log will be described with reference to FIGS. 19, 21, and 24. First, the second communication log comparison unit 45 duplicates the communication log table in FIG. 19, and creates a matching or non-matching column, which stores a flag, on the right side of the transmission destination port number column. A table including the matching or non-matching column is illustrated as a master communication log table T1m in FIG. 24. A state in which the communication log database DB1 in FIG. 5 stores the master communication log table T1m in FIG. 24 is indicated by a symbol Tm in FIG. 5.

Subsequently, the second communication log comparison unit 45 selects an IP address to be converted one by one among transmission source IP addresses stored in the transmission source IP address column of the master communication log table T1m in FIG. 24 from the drawing. The second communication log comparison unit 45 searches for an IP address, which matches the selected IP address, among IP addresses stored in the IP address (first block A) column of the server-corresponding table TR2 in FIG. 21.

In addition, the second communication log comparison unit 45 specifies an IP address at the same row as the IP address searched for among IP addresses stored in the IP address (second block B) column of the server-corresponding table TR2 in FIG. 21. That is, the second communication log comparison unit 45 specifies an IP address in the IP address (second block B) column which corresponds to the IP address searched for. In addition, the second communication log comparison unit 45 converts the IP address selected from the master communication log table Tim in FIG. 24 to the specified IP address. For example, the second communication log comparison unit 45 executes IP address conversion as “12.4.3.6 (before conversion: 12.0.3.6)” in the transmission source IP address column of the master communication log table T1m in FIG. 24.

The second communication log comparison unit 45 executes the selection, the search, the specification, and the conversion of the IP address with respect to the entire transmission source IP addresses stored in the transmission source IP address column. In addition, in a case where the selected IP address and the specified IP address are the same as each other, the second communication log comparison unit 45 may not execute the above-described conversion.

In addition, the second communication log comparison unit 45 selects an IP address to be converted, one by one, among transmission destination IP addresses stored in the transmission destination IP address column of the master communication log table T1m in FIG. 24. The second communication log comparison unit 45 searches for an IP address, which matches the selected IP address, among IP addresses stored in the IP address (first block A) column of the server-corresponding table TR2 in FIG. 21. In addition, the second communication log comparison unit 45 specifies an IP address in the same row as the IP address searched for among IP addresses stored in the IP address (second block B) column of the server-corresponding table TR2 in FIG. 21. In addition, the second communication log comparison unit 45 converts the IP address selected from the master communication log table T1m in FIG. 24 into the specified IP address. For example, the second communication log comparison unit 45 executes IP address conversion like “12.4.0.5 (before conversion: 12.0.0.5)” and “12.0.3.7 (before conversion: 12.4.3.7) in the transmission source IP address column of the master communication log table T1m in FIG. 24.

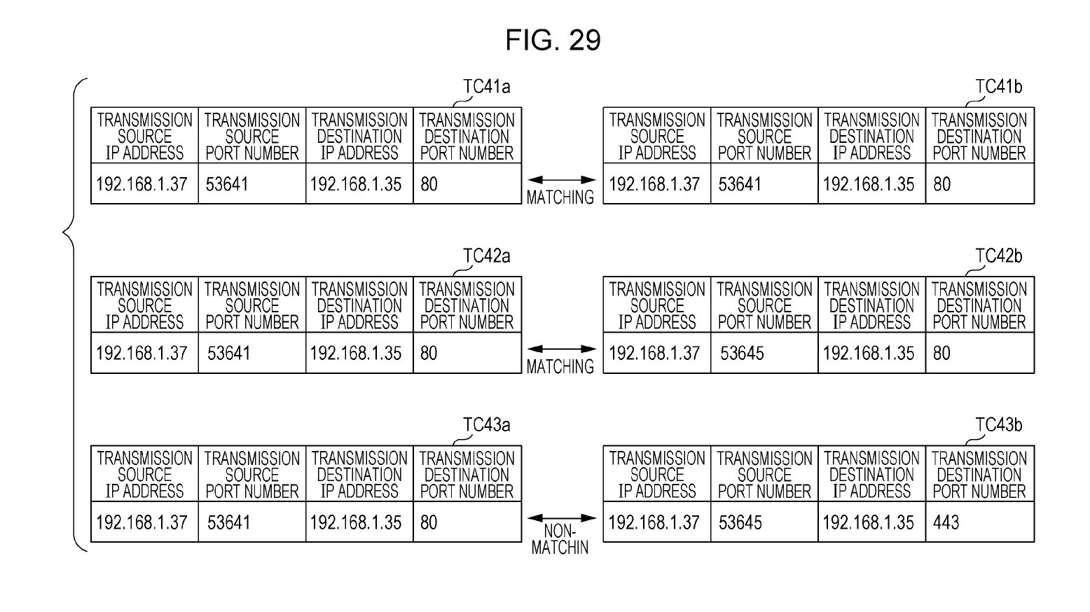

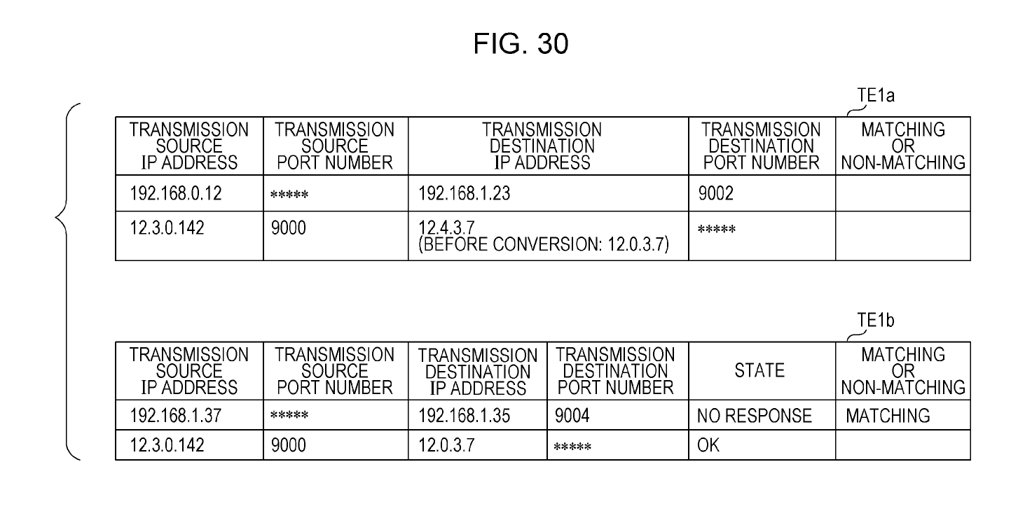

The second communication log comparison unit 45 executes the selection, the search, the specification, and the conversion of the IP address with respect to the entire transmission destination IP addresses stored in the transmission destination IP address column. A flag “matching” that is stored in the matching or non-matching column in FIG. 24 will be described later with reference to FIGS. 28 and 29. In addition, the second communication log comparison unit 45 may not perform the above-described conversion so as to suppress an increase in a processing load due to the conversion.

Addition of Matching or Non-Matching Column

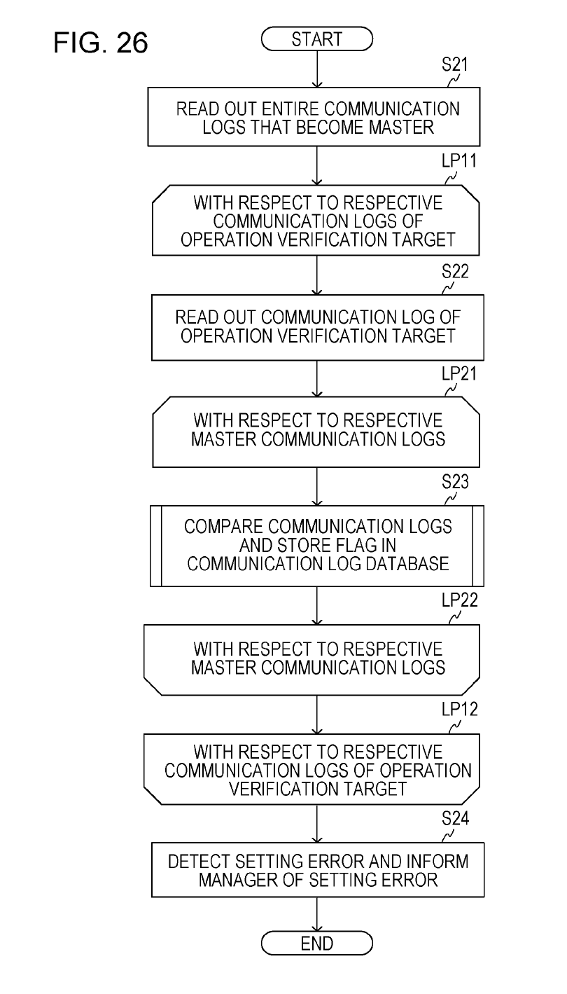

FIG. 25 is a diagram illustrating an example of a communication log table to which a matching or non-matching column is added, according to an embodiment. FIG. 25 shows an example in which a matching or non-matching column is added to the communication log table T1b in FIG. 20. The second communication log comparison unit 45 creates the matching or non-matching column, which stores a flag, on a right side of the state column of the communication log table Tib in FIG. 20. A table including the matching or non-matching column is illustrated as a communication log table T11b in FIG. 25. Here, at the time of creating the matching or non-matching column, a flag “matching” is not stored. In addition, the flag “matching” that is stored in the matching or non-matching column will be described later with reference to FIGS. 28 and 29. A state in which the communication log database DB1 in FIG. 5 stores communication log table T11b is indicated by a symbol Ts in FIG. 5.

Process of Detecting Setting Error

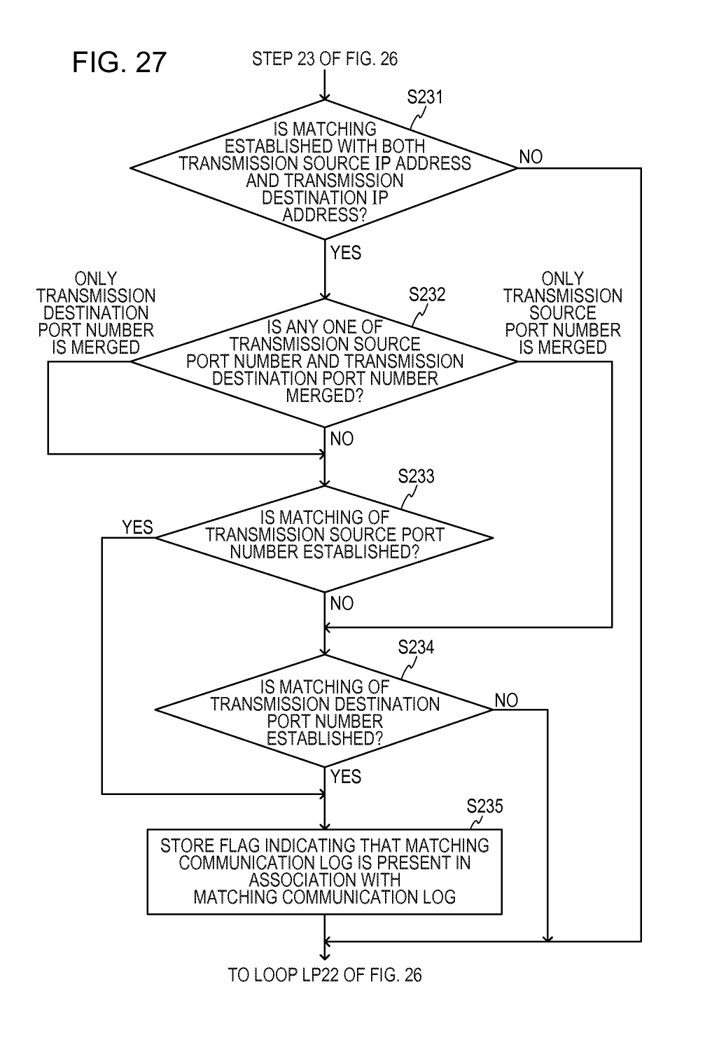

FIG. 26 is a diagram illustrating an example of an operational flow chart for a process of comparing communication logs and detecting a setting error, according to an embodiment.

Step S21: The second communication log comparison unit 45 reads out all of the communication logs, which becomes a master (standard) of the comparison process, from the communication log database DB1. Hereinafter, a communication log that becomes a master is appropriately described as a master communication log. Specifically, the second communication log comparison unit 45 reads out specific information (a transmission source IP address, a transmission destination IP address, a transmission source port number, and a transmission destination port number) of all of the communication logs which are stored in the master communication log table T1m in FIG. 24.

Step S22: The second communication log comparison unit 45 reads out a communication log of an operation verification target from the communication log database DB1. The communication log of an operation verification target is a communication log of the second block B 20b. Specifically, the second communication log comparison unit 45 reads out specific information of a communication log, which is not read-out, among a plurality of pieces of specific information of communication logs that are stored in the communication log table T11b in FIG. 25.

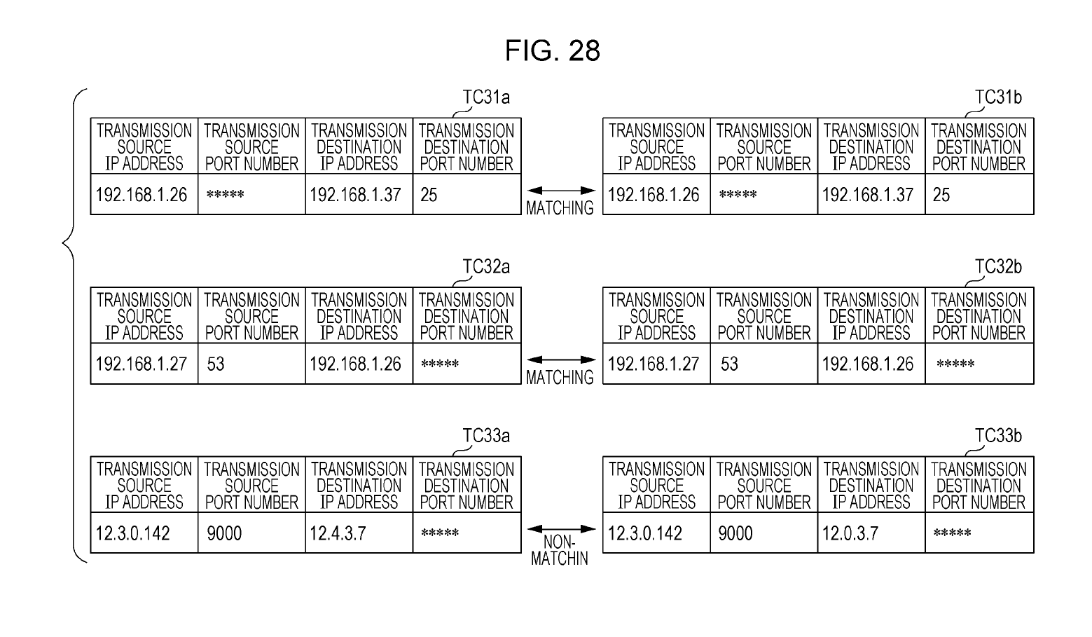

Step S23: The second communication log comparison unit 45 compares the communication log of the operation verification target which is read-out in step S22, and each master communication log, and sets a flag, which indicates that both of the communication logs match each other, to both of the communication logs. The process in step S23 will be described later in detail with reference to FIG. 27. The second communication log comparison unit 45 executes a process of comparing the communication log of the operation verification target which is read-out in step S22, and each master communication log, with respect to the entire master communication logs (loops LP21 and LP22).

Step S24: The error detection unit 46 detects a communication-related setting error, and the notification unit 47 makes a notification of the communication-related setting error detected by the error detection unit 46.

The second communication log comparison unit 45 executes the processes in step S22 and step S23 until all of the communication logs are read out from the communication log table T11b in FIG. 25 in step S22 (loops LP 11 and LP12).

FIG. 27 is a diagram illustrating an example of an operational flowchart for comparing communication logs and detecting a setting error, according to an embodiment. FIG. 27 shows the comparison of the communication logs in step S23 and the detection of the setting error in FIG. 26.

Step S231: The second communication log comparison unit 45 determines whether or not both a transmission source IP address and a transmission destination IP address of the master communication log, and both a transmission source IP address and a transmission destination IP address of the communication log of the operation verification target match each other. In a case of non-matching (NO in step S231), the process transitions to the loop LP22 in FIG. 26. In a case of matching (YES in step S231), the process transitions to step S232.

Step S232: The second communication log comparison unit 45 determines whether or not a transmission source port number of the master communication log and a transmission source port number of the communication log of the operation verification target are merged, or whether or not a transmission destination port number of the master communication log and a transmission destination port number of the communication log of the operation verification target are merged with each other.

Hereinafter, a case where the transmission source port number of the master communication log and the transmission source port number of the communication log of the operation verification target are merged with each other is described as a first case. In addition, a case where the transmission destination port number of the master communication log and the transmission destination port number of the communication log of the operation verification target are merged with each other is described as a second case.

Here, in the second case (it is determined in step S232 that only the transmission destination port is merged), the process transitions to step S233. In the first case (it is determined in step S232 that only the transmission source port is merged), the process transitions to step S234. In a third case other than the first case and the second case, the process transitions to step S233. In a case not corresponding to any of the first to third cases, the process transitions to the loop LP22 in FIG. 26.

Step S233: The second communication log comparison unit 45 determines whether or not the transmission source port number of the master communication log and the transmission source port number of a communication log of an operation verification target match each other. In a case of matching (YES in step S233), the process transition to step S235. In a case of non-matching (NO in step S233), the process transitions to step S234.

Step S234: The second communication log comparison unit 45 determines whether or not the transmission destination port number of the master communication log and the communication destination port number of the communication log of the operation verification target match each other. In a case of non-matching (NO in step S234), the process transitions to the loop LP22 in FIG. 26. In a case of matching (YES in step S234), the process transitions to step S235.

Step S235: The second communication log comparison unit 45 sets a flag, which indicating that matching communication logs are present, with respect to the matching communication logs. The matching communication logs are the master communication log and the communication log of the operation verification target which satisfy the condition in step S231 (YES in step S231) and the condition in step S233 or step S234 (YES in step S233 or YES in step S234).

Flag Setting

The flag setting described with reference to FIG. 27 will be described with reference to FIGS. 28 and 29. FIG. 28 is a diagram illustrating an example of matching or non-matching of a communication log in a state in which both of a transmission source port number and a transmission destination port number are merged, according to an embodiment.

A communication log TC31a is a master communication log indicated by a symbol P1 in FIG. 24. A communication log TC31b is a communication log of an operation verification target which is indicated by the symbol P1 in FIG. 25. A communication log TC32a is a master communication log indicated by a symbol P2 in FIG. 24. A communication log TC32b is a communication log of an operation verification target which is indicated by the symbol P2 in FIG. 25. A communication log TC33a is a master communication log indicated by a symbol P3 in FIG. 24. A communication log TC33b is a communication log of an operation verification target which is indicated by the symbol P3 in FIG. 25.

For example, the second communication log comparison unit 45 compares the communication log TC31a and the communication log TC31b. Here, a transmission source IP address (“192.168.1.26”) and a transmission destination IP address (“192.168.1.37”) which are included in the communication log TC31a, and a transmission source IP address and a transmission destination IP address which are included in the communication log TC31b match each other. In addition, transmission source port numbers included in the communication log TC31a and the communication log TC31b are merged (“*****”). In addition, a transmission destination port number (“25”) included in the communication log TC31a and a transmission destination port number (“25”) included in the communication log TC31b match each other. Accordingly, during comparison of both of the communication logs, the second communication log comparison unit 45 determines YES in step S231 in FIG. 27, determines that only the transmission source port is merged in step S232 in FIG. 27, and determines YES in step S234 in FIG. 27. Then, the process transitions to step S235.

The second communication log comparison unit 45 stores a flag “matching” in a row, which corresponds to the communication log TC31a (refer to the symbol P31 in FIG. 24), in the matching or non-matching column of the master communication log table Tim in FIG. 24 (step S235).

In addition, the second communication log comparison unit 45 stores a flag “matching” in a row, which corresponds to the communication log TC31b (refer to the symbol P31 in FIG. 25), in the matching or non-matching column of the communication log table T11b in FIG. 25 (step S235).

Next, for example, the second communication log comparison unit 45 compares the communication log TC32a and the communication log TC32b with each other. During comparison of both of the communication logs, the second communication log comparison unit 45 determines YES in step S231 in FIG. 27, determines that only the transmission destination port is merged in step S232 in FIG. 27, and determines YES in step S233 in FIG. 27. Then, the process transitions to step S235.

The second communication log comparison unit 45 stores a flag “matching” in a row, which corresponds to the communication log TC32a (refer to the symbol P32 in FIG. 24), in the matching or non-matching column of the master communication log table T1m in FIG. 24 (step S235).

In addition, the second communication log comparison unit 45 stores a flag “matching” in a row, which corresponds to the communication log TC32b (refer to the symbol P32 in FIG. 25), in the matching or non-matching column of the communication log table T11b in FIG. 25 (step S235).

The comparison process is repeatedly executed (refer to LP11 and LP12 in FIG. 26). As a result, for example, the second communication log comparison unit 45 compares the communication log TC33a and the communication log TC33b with each other. Here, a transmission destination IP address (12.4.3.7) included in the communication log TC33a and a transmission destination IP address (12.0.3.7) included in the communication log TC33b do not match each other. Accordingly, during comparison of both of the communication logs, the second communication log comparison unit 45 determines NO in step S231 in FIG. 27, and the process in step S235 is not executed. As a result, the second communication log comparison unit 45 does not store a flag “matching” in a row, which corresponds to the communication log TC33a (refer to the symbol P33 in FIG. 24), in the matching or non-matching column of the master communication log table T1m in FIG. 24 (empty column). In addition, the second communication log comparison unit 45 does not store a flag “matching” in a row, which corresponds to the communication log TC33b (refer to the symbol P33 in FIG. 25), in the matching or non-matching column of the communication log table T11b in FIG. 25 (empty column).

FIG. 29 is a diagram illustrating an example of matching or non-matching of a communication log in a state in which both of the transmission source port number and the transmission destination port number are not merged with each other, according to an embodiment.

Communication logs TC41a to TC43a are examples of a master communication log. Communication logs TC41b to TC43b are examples of the communication log of the operation verification target.

For example, the second communication log comparison unit 45 compares the communication log TC41a and the communication log TC41b. Here, a transmission source IP address (“192.168.1.37”) and a transmission destination IP address (“192.168.1.35”) which are included in the communication log TC41a, and a transmission source IP address and a transmission destination IP address which are included in the communication log TC41b match each other. In addition, a transmission source port number (“53641”) and a transmission destination port number (“80”) included in the communication log TC41a and a transmission source port number and a transmission destination port number included in the communication log TC41b match each other. Accordingly, during comparison of both of the communication logs, the second communication log comparison unit 45 determines YES in step S231 in FIG. 27, NO in step S232 in FIG. 27, and YES in step S233 in FIG. 27. Then, the process transitions to step S235.

The second communication log comparison unit 45 stores a flag “matching” in a row (not illustrated), which corresponds to the communication log TC41a, in the matching or non-matching column of the master communication log table Tim in FIG. 24 (step S235). In addition, the second communication log comparison unit 45 stores a flag “matching” in a row (not illustrated), which corresponds to the communication log TC41b, in the matching or non-matching column of the communication log table T11b in FIG. 25 (step S235).

For example, the second communication log comparison unit 45 compares the communication log TC42a and the communication log TC42b. Here, a transmission source IP address (“192.168.1.37”) and a transmission destination IP address (“192.168.1.35”) which are included in the communication log TC42a, and a transmission source IP address and a transmission destination IP address which are included in the communication log TC42b match each other. On the other hand, a transmission source port number (“53641”) included in the communication log TC42a and a transmission source port number (“53645”) included in the communication log TC42b do not match each other. However, a transmission destination port number (“80”) included in the communication log TC42a and a transmission destination port number (“80”) included in the communication log TC42b match each other.

Accordingly, during comparison of both of the communication logs, the second communication log comparison unit 45 determines YES in step S231 in FIG. 27, NO in step S232 and step S233 in FIG. 27, and YES in step S234 in FIG. 27. Then, the process transitions to step S235. In addition, the process in step S235 is illustrated in comparison between the communication log TC42a and the communication log TC42b, and thus a description thereof will not be repeated.

For example, the second communication log comparison unit 45 compares the communication log TC43a and the communication log TC43b. Here, a transmission source IP address (“192.168.1.37”) and a transmission destination IP address (“192.168.1.35”) which are included in the communication log TC43a, and a transmission source IP address and a transmission destination IP address which are included in the communication log TC43b match each other. However, a transmission source port number (“53641”) included in the communication log TC43a and a transmission source port number (“53645”) included in the communication log TC43b do not match each other. In addition, a transmission destination port number (“80”) included in the communication log TC43a and a transmission destination port number (“443”) included in the communication log TC43b do not match each other.

Accordingly, during comparison of both of the communication logs, the second communication log comparison unit 45 determines YES in step S231 in FIG. 27 and NO in step S232 to step S234 in FIG. 27, and does not execute the process in step S235.

As described above, the second communication log comparison unit 45 repetitively performs the above-described comparison between the master communication log and the communication log of the operation verification target. Specifically, the second communication log comparison unit 45 reads out the entire master communication logs stored in the master communication log table T1m in FIG. 24. In addition, the second communication log comparison unit 45 compares each of the read-out master communication logs and each of the communication logs stored in the communication log table T11b in FIG. 25. In addition, in a case where both of the communication logs match each other, the second communication log comparison unit 45 stores a flag “matching” in a row, which corresponds a matching communication log, in the matching or non-matching column of the communication log tables T1m and T11b.

Extraction of Setting Error Candidate

Through execution of the processes in steps S21 to S23 in FIG. 26, the second communication log comparison unit 45 stores a flag in the matching or non-matching column of the master communication log table T1m in FIG. 24, and stores a flag in the matching or non-matching column of the communication log table T11b in FIG. 25. In addition, the process transitions from the loop LP12 to step S24 in FIG. 26.

The error detection unit 46 extracts a setting error candidate based on the master communication log table T1m in FIG. 24 and the communication log table T11b in FIG. 25. A setting error candidate communication log is a communication log stored in a row, in which the flag “matching” is not stored (empty), in the matching or non-matching column of the master communication log table T1m in FIG. 24 and the communication log table T11b in FIG. 25. In addition, the setting error candidate communication log is a communication log stored in a row, in which “no response” is stored, in the state column of the communication log table T11b in FIG. 25.

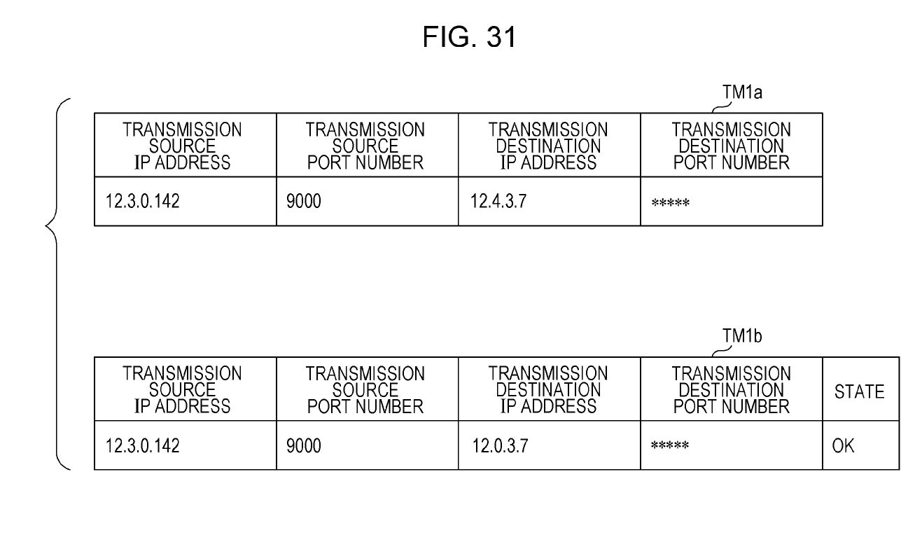

The error detection unit 46 detects the setting error based on a setting error candidate that is extracted, and analyzes the cause of the setting error. In addition, the notification unit 47 notifies a manager of the contents of the setting error and the case of the setting error. First, extraction of the setting error candidate will be described with reference to FIG. 30.

FIG. 30 is a diagram illustrating an example of setting error candidate extraction, according to an embodiment. FIG. 30 shows an example of setting error candidate extraction which is executed in step S24 in FIG. 26.

At an immediately previous stage of the detection of the setting error, the error detection unit 46 extracts the setting error candidate. The error detection unit 46 detects a communication log, which does not match second specific information included in a plurality of second communication logs (refer to FIG. 25), among a plurality of first communication logs (refer to FIG. 24) as a setting error communication log.

Specifically, among the plurality of first communication logs, the error detection unit 46 detects a communication log, in which matching is not established with a transmission source IP address and a transmission destination IP address which are included in the plurality of the second communication logs, as a first setting error communication log. In addition, among the plurality of first communication logs, the error detection unit 46 detects a communication log, in which matching is established with the transmission source IP address and the transmission destination IP address which are included in the plurality of second communication logs, but matching is not established with a transmission source port number and a transmission destination port number, as the first setting error communication log. Hereinafter, the first setting error communication log is appropriately described as a first setting error candidate communication log.

In the example of FIG. 24, the error detection unit 46 extracts the first setting error candidate communication log from a communication log group stored in the master communication log table T1m in FIG. 24. The first setting error candidate communication log is a communication log in which the flag “matching” is not stored in the matching or non-matching column. A symbol TE1a in FIG. 30 is a table illustrating two first setting error candidate communication logs that are extracted by the error detection unit 46.

In addition, among the plurality of second communication logs, the error detection unit 46 detects a communication log, in which matching is not established with a transmission source IP address and a transmission destination IP address which are included in the plurality of first communication logs, as a second setting error communication log. In addition, among the plurality of second communication logs, the error detection unit 46 detects a communication log, in which matching is established with the transmission source IP address and the transmission destination IP address which are included in the plurality of first communication logs, but matching is not established with a transmission source port number and a transmission destination port number, as the second setting error communication log. Hereinafter, the second setting error communication log is appropriately described as a second setting error candidate communication log.

In the example of FIG. 25, the error detection unit 46 extracts the second setting error candidate communication log from a communication log group stored in the communication log table T11b in FIG. 25. The second setting error candidate communication log is a communication log in which the flag “matching” is not stored in the matching or non-matching column. In addition, the error detection unit 46 detects (also, referred to as extracts) a second communication log including communication information indicating that communication state information is not normally executed, for example, a communication log in which “no response” is stored in the state column.

A symbol TE1b in FIG. 30 is a table illustrating a second setting error candidate communication log extracted by the error detection unit 46, and a second communication log including communication information indicating that the communication state information is not normally executed.

In addition, the error detection unit 46 detects a setting error of specific information that specifies a transmission source and a transmission destination which relate to the first and second setting error communication logs in a device of the second device group.

FIGS. 31 to 33 are diagrams illustrating an example of a process of detecting a setting error, according to an embodiment. FIGS. 31 to 33 show a process of detecting a setting error which is executed in step S24 in FIG. 26.

The error detection unit 46 detects a setting error by executing first to third detection processes different from each other. First, the first detection process will be described.

In the first detection process, the following assumptions are made. The manager sets a transmission source IP address “12.3.0.142” to a server (hereinafter, described as a server S1) in the first device group (for example, the first block A 20a) in which the operation verification is completed. In addition, the manager sets a transmission destination IP address “12.0.3.7” to communication software that is executed by the server S1. Here, the transmission destination server to which the transmission destination IP address “12.0.3.7” is set is described as a server D1.

In addition, the manager sets a transmission source IP address “12.3.0.142” to a server (hereinafter, described as a server S2) in the second device group (for example, the second block B 20b) which has the same function as the server S1 and which is an operation verification target. In addition, the manager sets an IP address “12.4.3.7”, which is obtained by customizing the transmission destination IP address “12.0.3.7”, to communication software that is executed by the server S2. However, actually, the manager does not perform the customization and erroneously sets the transmission destination IP address “12.0.3.7” not the IP address “12.4.3.7”. Here, a transmission destination server to which the transmission destination IP address “12.4.3.7” is set is described as a server D2.

According to the server-corresponding table TR2 in FIG. 21, the IP address “12.0.3.7” and the IP address “12.4.3.7” are respectively stored in the IP address (first block A) column and the IP address (second block B) column in the same row. In other words, the server D1 and the server D2 are same functional servers.

However, when the manager executes the operation verification with respect to the second device group that is an operation verification target, communication software of the server S2 creates a communication packet and transmits the communication packet. For example, the communication packet includes a transmission source IP address “12.3.0.142”, a transmission source port number “9000”, a transmission destination IP address “12.0.3.7” (erroneous setting), and a predetermined transmission destination port number. The transmission destination IP address “12.0.3.7” (erroneous setting) of the communication packet is not stored in the IP address (second block B) column of the server-corresponding table TR2 in FIG. 21. Therefore, the communication packet is transmitted to a block (for example, the first block A 20a) other than the second block B 20b, and a server of this block receives the communication packet. In addition, the server that receives the communication packet transmits a positive response packet (also, referred to as an ACK packet) to communication software of the server S2. As a result, the communication software of the server S2 stores a communication log including the transmission source IP address “12.3.0.142”, the transmission source port number “9000”, the transmission destination IP address “12.0.3.7” (erroneous setting), a predetermined transmission destination port number, and a communication state “OK” (refer to the symbol TE1b in FIG. 30).

The communication is caused by the erroneous setting of the IP address, and thus it is desirable to correct the erroneous setting of the IP address. Accordingly, the error detection unit 46 of the management device 4 executes the following processes.

The error detection unit 46 detects a communication log, in which matching is established in a transmission source IP address and a transmission source port number, from the first setting error communication logs and the second setting error communication log as a third setting error communication log. In addition, the error detection unit 46 detects a communication log in which matching is established in a transmission destination IP address and a transmission destination port number, as a fourth setting error communication log.

In addition, the error detection unit 46 detects a setting error of a transmission source IP address and a transmission destination IP address which relate to the third and fourth setting error communication logs in a device of the second device group. In addition, the notification unit 47 makes a notification of the setting error that is detected by the error detection unit 46.

Hereinafter, a description will be made in detail. The error detection unit 46 compares the first setting error candidate communication log and the second setting error candidate communication log with each other. In addition, the error detection unit 46 extracts a communication log in which matching is established in a transmission source IP address and a transmission source port number or a communication log in which matching is established in a transmission destination IP address and a transmission destination port number from the first and second setting error candidate communication logs. In a case of the example illustrated in FIG. 30, as the communication log in which matching is established in the transmission source IP address and the transmission source port number, the error detection unit 46 extracts a communication log having an transmission source IP address “12.3.0.142” and a transmission source port number “9000” from the first and second setting error candidate communication logs.

Specifically, the error detection unit 46 extracts a communication log TM1a in FIG. 31 from two communication logs indicated by the symbol TE1a. The communication log TM1a includes a transmission source IP address “12.3.0.142”, a transmission source port number “9000”, a transmission destination IP address “12.4.3.7”, and a transmission destination port number “*****”. In addition, the error detection unit 46 extracts a communication log TM1b in FIG. 31 from two communication logs indicated by the symbol TE1b. The communication log TM1b includes a transmission source IP address “12.3.0.142”, a transmission source port number “9000”, a transmission destination IP address “12.0.3.7”, and a transmission destination port number “*****”.

However, as described above, the transmission destination IP address “12.0.3.7” included in the communication log TM1b in FIG. 31 is not stored in the IP address (second block B) column of the server-corresponding table TR2 in FIG. 21. As described above, in a case where an IP address not stored in the IP address (second block B) column in FIG. 21 is present among IP addresses included in the communication log TM1b in FIG. 31, the error detection unit 46 estimates that a setting error relating to the IP address occurs. The IP address estimated as an IP address in which the setting error occurs is the transmission destination IP address “12.0.3.7”.

Accordingly, the error detection unit 46 estimates that an error is made during setting of the communication-related information in a server to which the transmission source IP address “12.3.0.142” of the communication log TM1b is set. In addition, the transmission destination IP address “12.0.3.7” is stored in the IP address (first block A) column of the server-corresponding table TR2 in FIG. 21, and thus the error detection unit 46 estimates that the IP address “12.4.3.7” corresponding to the transmission destination IP address is a correct IP address.

In addition, the notification unit 47 notifies the manager of such assumptions as an error is made during setting of the communication-related information in a server to which the transmission source IP address “12.3.0.142” is set and a correct IP address is “12.4.3.7”.

Next, the second detection process will be described. The error detection unit 46 detects a fifth setting error communication log other than the third and fourth setting error communication logs from the first setting error communication logs. The notification unit 47 detects a setting error of a transmission source IP address that relates to the fifth setting error communication log in a device of the second device group, and gives a notification of the setting error that is detected.

A description will be made in detail. The error detection unit 46 detects whether or not a communication log present only in the first device group (for example, the first block A 20a) in which the operation verification is completed is present. As described above, a hardware configuration and a software configuration of the second device group (for example, the second block B 20b) that is an operation verification target are the same or substantially the same as a hardware configuration and a software configuration of the first block A 20a. In this case, communication, in which a transmission source and a transmission destination are regarded as the same in each case, is highly likely to occur in the first block A 20a and the second block B 20b.

Therefore, in a case where a communication log present only in the first block A 20a is present, communication, which relates to the communication log, may not be executed in the second block B 20b. Specifically, in a transmission source server, which executes the communication log-related communication, of the second block B 20b, software that executes a service to be provided by the server may not operate. In addition to this, there is a high possibility that a setting error such as any communication setting information not being set to the server has occurred.

Description will be made with respect to a specific process of detecting whether or not the communication log present only in the first block A 20a is present. The error detection unit 46 extracts a communication log other than the communication log extracted in the first detection process from the two communication logs indicated by the symbol TE1a in FIG. 30. The communication log that is extracted is an example of the fifth setting error communication log, and is a communication log TM11a in FIG. 32. The communication log TM11a is a communication log including a transmission source IP address “192.168.0.12”, a transmission source port number “*****”, a transmission destination IP address “192.168.1.23”, and a transmission destination port number “9002”.

The communication log is a communication log that is present only in the first block A 20a.

The notification unit 47 notifies the manager of occurrence of a setting error relating to a communication log detected by the error detection unit 46. The notification unit 47 gives a notification to the manager in order for the manager to confirm whether or not in a server in the second block B 20b to which the transmission source IP address “192.168.0.12” is set and which executes the communication relating to the communication log, software that executes a service to be provided by the server operates. In addition, the notification unit 47 gives a notification to the manager in order for the manager to confirm whether or not communication setting information set to the server or the software executed by the server is correct.

Next, the third detection process will be described. The error detection unit 46 extracts the second setting error candidate communication log in which “no response” is stored in the state column. With regard to the communication log corresponding to “no response”, there is a high possibility that a communication packet is transmitted from a transmission source server to a transmission destination server, but the communication packet fails to reach the transmission destination server. As the cause of this failure, for example, it can be considered that a fire wall provided on the network between the transmission source server and the transmission destination server blocks the above-described communication packet. Additionally, as the cause of the failure, a setting error of a routing table provided to a router provided on the above-described network may be considered.

Specifically, the error detection unit 46 extracts a communication log in which “no response” is stored in the state column from the two communication logs indicated by the symbol TE1b in FIG. 30. The communication log that is extracted is a communication log TM11b in FIG. 33. The communication log TM11b is a communication log including a transmission source IP address “192.168.1.37”, a transmission source port number “*****”, a transmission destination IP address “192.168.1.35”, and a transmission destination port number “9004”.

According to the communication log in which “no response” is stored in the state column, it can be estimated that a communication packet transmitted from a transmission source server to which the transmission source IP address “192.168.1.37” is set to the port number “9004” of a transmission destination server to which the transmission destination IP address “192.168.1.35” is set may be blocked.

Accordingly, the notification unit 47 gives a notification to the manager in order for the manager to confirm whether or not setting of the fire wall and the like, which are provided on the network (communication path) ranging from the transmission source server to the transmission destination server, is correct.

As described above, according to the managing device according to this embodiment, a setting error of communication-related information is automatically detected and a manager is notified of the information. In addition to this, the cause of the setting error is also estimated and the manager is notified of this estimation. Accordingly, the manager can easily specify the setting error and can easily perform cause analysis, and thus convenience for the manager increases. In addition, the number of processes of correcting the setting error and time taken to correct the setting error are reduced, and thus it is possible to quickly terminate the operation verification. As a result, convenience for a user of an information processing system is improved, and economic benefit to a business operator is also improved.

In addition, the management device of this embodiment executes a process of detecting the setting error by using an IP address, a port number, and a communication state of a communication log recorded during a communication process executed by a communication software of a server.

Accordingly, it is not desired to introduce additional complex software for detection of the setting error other than the management device, and thus it is possible to suppress an increase in system complication and the cost of system construction. Additionally, only the communication logs are recorded on the server, and thus it is possible to suppress an increase in a processing load in the server. In addition, in the management device, communication logs are acquired, and only a simple comparison process is executed with respect to the communication logs that are acquired, and thus it is possible to suppress an increase in a processing load.

In addition, the management device of this embodiment acquires a communication log, which becomes a master during comparison of communication logs, from the first block A 20a in operation. According to the management device, it is possible to perform operation verification of the second block B 20b without stopping operation of the first block A 20a during comparison of the communication logs. As a result, the first block A 20a operates during operation verification of the second block B 20b, and thus it is possible to continuously provide service to a user of a cloud system.

In addition, the management device 4 may acquire specific information, which specifies a transmission source and a transmission destination of communication, from header information of a communication packet that is transmitted and received on a network of the first block A 20a as a communication log of the first block A 20a. Similarly, the management device 4 may acquire specific information, which specifies a transmission source and a transmission destination of communication, from header information of a communication packet that is transmitted and received on a network of the second block B 20b as a communication log of the second block B 20b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A search method that is executed by a search device in a system in which first and second device groups are connected to each other, the search method comprising:
acquiring first history information that specifies transmission sources and transmission destinations of communication executed between devices in the first device group, and second history information that specifies transmission sources and transmission destinations of communication executed between devices in the second device group; and
performing a search process including searching across the first and second history information for a pair of a first device in the first group and a second device in the second group, by comparing the first and second history information, the first device having a same function as the second device.

2. The search method of claim 1, wherein
the first and second history information each include transmission source Internet protocol (IP) addresses that are set to transmission source devices of the communication, and transmission destination IP addresses and port numbers which are set to transmission destination devices of the communication; and
the search process includes:
determining whether or not there exists a first common port number that is included in both the first and second history information by comparing the port numbers of the first history and the port numbers of the second history, and
searching for a pair of the first and second devices, based on pieces of the first and second history information including the first common port number.

3. The search method of claim 2, wherein
in the search process, when it is determined that there exists the common port number included in both the first and second history information, a device to which a transmission source IP address contained in a piece of the first history information including the first common port number is set and a device to which a transmission source IP address contained in a piece of the second history information including the first common port number is set are searched for as a pair of the first and second devices, respectively.

4. The search method of claim 2, wherein
in the search process, when it is determined that there exists the first common port number included in both the first and second history information, a device to which a transmission destination IP address contained in a piece of the first history information including the first common port number is set and a device to which a transmission destination IP address contained in a piece of the second history information including the first common port number is set are searched for as a pair of the first and second devices, respectively.

5. The search method of claim 2, wherein
in the search process, when it is determined that there exists the common port number included in both the first and second history information, a device to which a transmission source IP address contained in a piece of the first history information including the first common port number is set and a device to which a transmission source IP address contained in a piece of the second history information including the first common port number is set are searched for as a pair of the first and second devices, respectively, and a device to which a transmission destination IP address contained in a piece of the first history information including the first common port number is set and a device to which a transmission destination IP address contained in a piece of the second history information including the first common port number is set are searched for as a pair of the first and second devices, respectively.

6. The search method of claim 5, wherein
the search process includes:
determining whether or not a third device that has not been searched for as the first one or more devices is present among a plurality of communication destination devices with which devices in the first device group communicate, with reference to the first history information, and
determining whether or not a fourth device that has not been searched for as the second device is present among a plurality of communication destination devices with which devices in the second device group communicate, with reference to the second history information; and
when it is determined that a port number contained in a piece of the first history information that includes an IP address set to the third device as a transmission destination IP address, and a port number contained in a piece of the second history information that includes an IP address set to the fourth device as a transmission destination IP address match each other, in the search process, a pair of the third and fourth devices are searched for as a pair of the first and second devices, respectively.

7. The search method of claim 6, wherein
the search process further includes:
extracting first exclusion history information by excluding, from the first history information, pieces of the first history information that each include, as transmission source and destination IP addresses, IP addresses that have been set to two devices each searched for as the first device in the first device group;
extracting second exclusion history information by excluding, from the second history information, pieces of the second history information that each include, as transmission source and destination IP addresses, IP addresses that have been set to two devices each searched for as the second device in the second device group; and
when it is determined that there exists a second common port number included in both the first and second exclusion history information, searching for, as a pair of the first and second devices, a device to which a transmission source IP address contained in a piece of the first history information including the second common port number is set and a device to which a transmission source IP address contained in a piece of the second history information including the second common port number is set, respectively, and searching for, as a pair of the first and second devices, a device to which a transmission destination IP address contained in a piece of the first history information including the second common port number is set and a device to which a transmission destination IP address contained in a piece of the second history information including the second common port number is set, respectively.

8. The search method of claim 6, wherein
the search process further includes:
extracting first exclusion history information by excluding, from the first history information, pieces of the first history information that each include, as a transmission source IP address, an IP address that has been set to a device searched for as the first device in the first device group;
extracting second exclusion history information by excluding, from the second history information, pieces of the second history information that each include, as a transmission source IP address, an IP address that has been set to a device searched for as the second device in the second device group; and
when it is determined that there exists a second common port number included in both the first and second exclusion history information, searching for, as a pair of the first and second devices, a device to which a transmission destination IP address contained in a piece of the first history information including the second common port number is set and a device to which a transmission destination IP address contained in a piece of the second history information including the second common port number is set, respectively.

9. The search method of claim 6, wherein
the search process further includes:
extracting first exclusion history information by excluding, from the first history information, pieces of the first history information that each include, as a transmission destination IP address, an IP address that has been set to a device searched for as the first device in the first device group;
extracting second exclusion history information by excluding, from the second history information, pieces of the second history information that each include, as a transmission destination IP address, an IP address that has been set to a device searched for as the second device in the second device group; and
when it is determined that there exists a second common port number included in both the first and second exclusion history information, searching for, as a pair of the first and second devices, a device to which a transmission source IP address contained in a piece of the first history information including the second common port number is set and a device to which a transmission source IP address contained in a piece of the second history information including the second common port number is set, respectively.

10. The search method of claim 3, wherein
the search process includes:
determining whether or not third devices that have not been searched for as the first device are present among a plurality of communication destination devices with which devices in the first device group communicate, with reference to the first history information;
determining whether or not fourth devices that have not been searched for as the second device are present among a plurality of communication destination devices with which devices in the second device group communicate, with reference to the first history information;
calculating a degree of similarity between port numbers that have been respectively set to the third devices and port numbers that have been respectively set to the fourth devices; and
searching for, as a pair of the first and second devices, a device to which a transmission destination IP address of a piece of the first history information including a port number having a highest degree of similarity is set and a device to which a transmission destination IP address of a piece of the second history information including a port number having the highest degree of similarity is set, respectively.

11. The search method of claim 1, further comprising
storing, in a storage device, an IP address set to the first device in the first device group and an IP address set to the second device in the second device group, in association with each other.

12. A search device in a system in which first and second device groups are connected to each other, the search device comprising:
a processor; and
a memory coupled to the processor, the memory configured to store first history information that specifies transmission sources and transmission destinations of communication executed between devices in the first device group, and second history information that specifies transmission sources and transmission destinations of communication executed between devices in the second device group, wherein
the processor is configured:
to acquire the first and second history information, and
to search across the first and second history information for a pair of a first device in the first group and a second device in the second group, by comparing the first and second history information, the first device having a same function as the second device.

13. A non-transitory, computer-readable recording medium having stored therein a program for causing a computer to execute a process, the computer being included in a system in which first and second device groups are connected to each other, the process comprising:
acquiring first history information that specifies transmission sources and transmission destinations of communication executed between devices in the first device group, and second history information that specifies transmission sources and transmission destinations of communication executed between devices in the second device group; and
searching across the first and second history information for a pair of a first device in the first group and a second device in the second group, by comparing the first and second history information, the first device having a same function as the second device.
